(19) United States
(12) Patent Application Publication
(10) Pub. No.: US 2025/0131492 A1
(43) Pub. Date: Apr. 24, 2025

(54) CONSUMER COLLECTIONS AND SERVICING (CCS) ANALYTICS PLATFORM AND CCS APPLICATION

(71) Applicant: Wells Fargo Bank, N.A., San Francisco, CA (US)

(72) Inventors: Timothy Jacob Manges, Windber, PA (US); Thomas Mang'era Ogwang'i, Youngsville, NC (US); Quang V. Tran, Davidson, NC (US)

(21) Appl. No.: 18/493,370

(22) Filed: Oct. 24, 2023

(51) Int. Cl. G06Q 40/02

(52) U.S. Cl. CPC G06Q 40/02

(57) ABSTRACT

Disclosed in some examples are methods, systems, devices, and machine-readable medium for providing a consumer collections and servicing analytics platform and application to simplify data analyst search and analysis of data from disparate data sources. The platform and application ingest data into a centralized data repository, from a plurality of disparate data sources. The application transforms the ingested data into standardized data using one or more standardized formats and applies custom processing algorithms and data enrichment techniques to the standardized data to generate enriched data. The application automates manual data collection and reporting processes using the enriched data and causes a user interface to be displayed to the user device, the user interface including self-service access to the enriched data in the centralized data repository.

### TECHNICAL FIELD

The present disclosure generally relates to special-purpose machines that aggregate, combine, or collect data from disparate sources for ease in data searching, and more particularly to systems, methods, and computer programs in the field of online banking and financial services for a consumer collections and servicing analytics platform and application.

### BACKGROUND

Modern business enterprises depend on a plurality of technological systems for sustainable day-to-day operations. These technological systems are indispensable, and it is critical for success of the business enterprises that the technological systems are fully functional, updated, and easy to use. In addition, to maintain the growth needed to sustain operations, it is important that the business enterprises stay on the leading edge of technology by assessing a variety of needs, collecting data, and providing valuable computational resources including data aggregation and analytics. Improved systems and methods for data collection, aggregation, and analysis of technological requirements are needed.

Entities may store resources in one or more resource stores. New advancements in technology and in network communications have made finer-grained monitoring and collection of data stored in these resource stores possible. For example, entities can now monitor and update resource allocations in real-time or near real-time using network-based communications tools provided by network-based resource stores. These tools also enable entities to continuously update and optimize their resource allocation strategies by changing which resources are aggregated, adding source data resources, and providing analytics searching mechanism to users. Resource allocation strategies may be defined as an allocation of presently available and/or future expected resources to one or more resource stores.

The performance of modern software components often depends upon both other software components, as well as available hardware resources. Software dependencies may include standardized libraries, frameworks, toolkits, application programming interfaces (APIs), and the like. These dependencies may be components linked with the software component when the software code of the component is compiled or may be external software components that the software component communicates with or uses during run-time. Software dependencies may also extend to available hardware resources and operating environments. For example, the software component's performance may change based upon the hardware resources available to it. These hardware and software dependencies may in turn, have their own dependencies, which form a dependency chain.

### BRIEF DESCRIPTION OF THE SEVERAL VIEWS OF THE DRAWINGS

The present disclosure will be apparent from the following more particular description of examples of embodiments of the technology, as illustrated in the accompanying drawings. The drawings are not necessarily to scale, emphasis instead being placed upon illustrating embodiments of the present disclosure. In the drawings, like numerals may describe similar components in different views. Like numerals having different letter suffixes may represent different instances of similar components. The drawings illustrate generally, by way of example, but not by way of limitation, various embodiments discussed in the present document. Various embodiments in accordance with the present disclosure will be described with reference to the drawings, in which:

FIG. 1 illustrates an example of one existing architectural overview for sourcing data from disparate sources to be aggregated.

FIG. 2 illustrates an aspect of a consumer collections and servicing analytics platform and application, in accordance with one embodiment.

FIG. 3 illustrates a data flows state diagram, in accordance with one embodiment.

FIG. 4 illustrates a first aspect of a capabilities view of a system architecture, in accordance with one embodiment.

FIG. 5 illustrates a second aspect of a capabilities view of the system architecture of FIG. 4, in accordance with one embodiment.

FIG. 6 illustrates a first aspect of a physical view of a system architecture, in accordance with one embodiment.

FIG. 7 illustrates a second aspect of a physical view of the system architecture of FIG. 6, in accordance with one embodiment.

FIG. 8 illustrates an aspect of a customer interaction diagram, in accordance with one embodiment.

FIG. 9 illustrates a flowchart of a method for interfacing a computing system with a user device, in accordance with one embodiment.

FIG. 10 is a block diagram illustrating an example architecture of a user computing device, in accordance with some embodiments.

FIG. 11 is a block diagram illustrating one example of a software architecture for a computing device, in accordance with some embodiments.

FIG. 12 illustrates a machine-learning pipeline, according to some example embodiments.

FIG. 13 illustrates training and use of a machine-learning program, according to some example embodiments.

FIG. 14 illustrates an example diagrammatic representation of a machine in the form of a computer system within which a set of instructions may be executed for causing the machine to perform any one or more of the methodologies discussed herein, according to some example embodiments.

### DETAILED DESCRIPTION

The description that follows includes systems, methods, techniques, instruction sequences, machine-readable media, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

### Overview

Example methods, systems, and computer programs are directed to enabling consumer collections and servicing (CCS) business users and analysts to perform data analysis and receive reporting and insights on data related to a financial institution and its customers, such as daily delinquency tracking, agent performance management, and additional CCS data. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

As used throughout example embodiments of the present disclosure and for the purposes of this description, the phrase “consumer collections and servicing analytics platform and application” may be referred to as and used interchangeably throughout with the terms “collections and analytics platform,” “CCS application,” “data lake platform,” or simply “the platform.” For purposes of this description, the terms “consumer collections and servicing analytics platform” and “CCS application” generally refer to a data insight platform and/or application that comprises an integrated set of technologies to enable enhanced analytics and decision-making across various financial processes and customer (e.g., consumer, user, etc.) interactions. More specifically, the terms “CCS platform” and “CCS application” refer to a set of technical capabilities that allows more advanced business decision making and data insights generation in the consumer collections activities that a financial institution undertakes. The platform and application according to examples of the present disclosure, incorporate high-performance data processing frameworks to rapidly ingest and analyze high volumes of structure and unstructured data from diverse, and often siloed, sources. Advanced integration capabilities allow for real-time consolidation of disparate data silos into a unified analytics foundation. Such a unified analytics foundation can include machine learning techniques (e.g., predictive modeling, clustering, classification, etc.) to generate actionable insights and intelligence. The platform further includes visual analytics tools that provide intuitive exploration and dashboards for business (e.g., non-technical) users. The platform facilitates continuous data training and model development to incrementally improve decision accuracy. For example, by combining scalable data infrastructure, intelligent algorithms, and/or customizable delivery mechanisms, the data insight platform can power next-generation analytics to optimize outcomes for customer interactions and other financial workflows. For example, example embodiments of the data insight platform can provide for faster data processing, servicing of higher volumes of data, with an ability to bring disparate data together in a real-time or near-real-time manner in order to drive business decisions and modernize data analytics capabilities. The data insight platform provides an agile, low-latency analytics environment that transforms data into strategic, operation, and tactical insights for enhanced risk assessment, customer engagement, portfolio management, and other financial institution needs.

Example embodiments of the present disclosure are directed to systems, methods, computer programs, and machine-readable media that ingests data from multiple disparate sources into a centralized data lake repository (e.g., an enterprise data lake) for use by the consumer collections and servicing analytics platform and application. Generally, data lakes can be built on cloud object storage to provide financial institutions with a centralized repository to store vast amounts of structured, semi-structured, and unstructured data. Such data lakes allow consolidating data from across the organization into a single accessible location. Cloud object stores can scale to petabytes of capacity and support any type of data. A data lake built on cloud object storage gives financial institutions (e.g., banks, firms, etc.) the ability to cost-effectively accumulate data from customer transactions, product databases, web traffic, IoT sensors, clickstreams, social media, and other sources. Storing this raw, granular data in the data lake preserves it for future analytics needs. Additionally, the data lake platform approach according to examples decouples data storage from data processing, which further enables flexibility. Once data is stored in the data lake, it can be accessed on demand for downstream analytics. For example, data scientists, analysts, engineers, and other users can run batch jobs, queries, and artificial intelligence (AI) workflows directly against the data lake to gain insights. Cloud data lakes provide scalable, durable, and low-cost storage to support both real-time and historical analytics on vast financial data assets.

The system enables key enterprise-scale foundational capabilities on CCS data to power the business outcomes. The consumer collections and servicing (CCS) application is created on an enterprise data lake platform for enabling custom and cross-domain data curations, historical data aggregation, and off-lake application data aggregation. For example, the system transforms and standardizes the ingested data into consistent formats, and stores both raw and curated versions of the data in the enterprise data lake. The system implements custom data preparation techniques adapted to the needs of financial institutions; for example, including domain-specific rules and calculations on the aggregated data to generate enriched data and analyzes customer journeys and interactions across channels using the enriched data. The system automates manual data collection and reporting processes to provide users with real-time or near-real-time analytics and insights. The system enables non-technical business users to perform self-service analytics on the data lake through simplified interfaces and natural language search capabilities. The system further maximizes customer contact and engagement by identifying optimal communication channels and times using analytics on the aggregated customer data. The system adheres to regulatory requirements around customer contact frequency while optimizing engagement, and leverages data management capabilities like metadata, cataloging, lineage, and quality to support the data preparation and analytics.

Today, data is spread everywhere, and data capabilities do not always allow for interoperability or interaction, such that getting access to data takes too long and prevents fast answers to urgent questions. Additionally, many users lack knowledge of where to source the required data and/or knowledge of the data needed to power capabilities and experiences desired by financial institutions. Even for experienced technical data analysts, it is difficult, and time consuming for the user to understand the data and know they have the correct data for the ultimate purpose. Additional problems exist with related to data quality, source, and/or accessibility. Entities having multiple resource allocations with different network-based resource allocation systems (hereinafter resource store systems) must contact multiple resource store systems to obtain the status of their resource allocations. This involves navigating to an application or network site, authenticating, and then navigating through the application or site to find the requisite information. This is both inconvenient for the entity, wastes time, and computing resources. Thus, the disparate resource allocation store systems present technical problems whereby an entity must contact separate resource allocation stores which waste network resources, computational resources, and the like.

With regard to current data aggregation and analytics systems, technical challenges arise relating to gaining access to data that is spread everywhere, as well as various data systems within enterprise architecture lacking interoperability to enable seamless exchange of information. For example, traditional approaches for data aggregation fail to implement enterprise-wide data accessibility and aggregation capabilities to consolidate the organization's distributed and heterogenous data assets into an integrated and easily searchable infrastructure. Further existing approaches exhibit fragmentation across siloed data repositories that impede a unified view of organizational data assets.

Examples of the present disclosure overcome the technical challenges in existing systems by enabling key enterprise-scale foundation capabilities on consumer collections and servicing (CCS) data to power the business outcomes. Thus, example embodiments present a newly created application built on an enterprise data lake platform for custom and cross-domain data curation, data aggregation, and off-lake application data combination for use by technical data analysts and novice users alike.

Examples of the present disclosure further overcome technical challenges by developing master data management practices, metadata repositories, and data catalogs to inventory, map, and govern data elements dispersed across various business systems, databases, data warehouses, and additional data source locations. Examples can include a cohesive aggregation framework to ingest, reconcile, an augment data from disparate sources into one or more unified layers to enable single point accessibility to authoritative information. For example, such advanced integration technologies provide for systematically extracting, transforming, and loading both structure and unstructured data from legacy and modern data stores. The aggregated data corpus can then power advanced analytics and drive data democratization by making trustworthy and timely information available and discoverable across the enterprise. Including robust aggregation mechanisms, the financial institution can gain comprehensive visibility into its data assets and maximize their business value.

Example embodiments of the present disclosure improve upon existing data analytics models and overcome current technical challenges related to fragmentation of siloed data repositories by implementing capabilities that enable heterogenous data systems to intercommunicate in a standardized, governed manner providing the ability to fully harness the value of enterprise data. For example, example embodiments provide the creation and adoption of architectural principles and existing, but currently unconnected, technologies focused on enabling integration, accessibility, findability, coordinated management of data across an institutional information landscape, and the like.

Examples of the system ingests and aggregates data from multiple disparate sources, both structured and unstructured, into a centralized data repository. The data sources may include operational systems, databases, Internet of Things (IoT) devices, files, etc. across the enterprise. Where the centralized repository comprises an enterprise data lake (EDL) built on a scalable distributed file system capable of storing extremely large volumes of data efficiently. The EDL employs a schema-on-read approach, allowing data to be captured at the source without extensive modeling. Data is ingested in batches and streams using automated configurable connectors and pipelines, and metadata tags are applied to enable self-describing data. The system provides a platform and application that encompasses capabilities to, for example, catalog data elements, establish common semantics and metadata standards, map linkages across domains, implement master data management, provision discovery services, enable multi-directional data connectivity through enterprise integration, and more. By implementing data management practices and infrastructure, organizations can overcome existing technological challenges by shifting from disparate data silos to a cohesive data fabric, enabling users with comprehensive access to accurately, actionably, and timely access data from disparate sources in a single platform.

Example embodiments of the platform and/or application transform and standardize ingested data. As data is captured in the EDL, it is transformed into standardized formats and structures. The ingestion process maps raw data elements to common standardized data types and schemas. Cleansing routines validate data integrity, normalize formats, filter noise, and the like. This transformation and standardization layer enables downstream data interoperability and consistency for both analytics and governance.

Example embodiments of the platform and/or application enrich data by applying custom logic and calculations using financial data analysis formulas, procedures, and/or custom processing algorithms tailored to the financial industry (e.g., online banking, etc.) to generate proprietary data transformation methods for generating insights. For example, industry-specific data modeling and enhancement is performed on data collocated from tens-to-hundreds of disparate data sources in order to adapt data preparation techniques to the needs of financial institutions. Example embodiments of the platform and application provide financial data manipulation and enhancement techniques including automated financial data aggregation, analysis, and enrichment process(es) to customize financial data. Custom logic, rules, and calculations are implemented programmatically on the aggregated data in the EDL to generate enriched analytic datasets tailored to business needs. The custom logic creates derived attributes, aggregations, summaries, and other enrichments that go beyond the raw data, and provides customized financial data processing and augmentation functionality. Enrichments may include layered aggregations based on hierarchies, relationships, or temporal factors. The custom logic encapsulates domain expertise for maximizing analytic utility, including, for example, domain-specific rules and calculations.

Additional example embodiments provide aggregated data from a plurality of disparate sources for self-service analytics via simplified user interfaces. Intuitive dashboards, natural language search, interactive visualizations, and the like are provided on top of the enriched data to enable business users to perform self-service analytics, where controls restrict data access based on user roles and needs. These interfaces remove the need for technical skills to find, understand, and analyze relevant data. Users are empowered to get insights quickly without information technology (IT) user involvement. For example, a natural language search capability allows users to query the EDL using conversational user inputs. Search algorithms interpret the intent of natural language queries and identify relevant data assets. This enables intuitive exploration without requiring users to know query languages or technical syntax; natural language search makes it easy to find data in the EDL.

Examples further provide developed semantic parsing models to interpret free-form queries expressed in business terminology and map them to formal query structures executable against the EDL. For example, by leveraging techniques such as machine learning, natural language processing, neural networks, and the like used to analyze query intent and extract entities without requiring the user to have SQL training or other specific knowledge associated with data analysts. Examples of the consumer collections and servicing analytics platform described in the present disclosure provide for enriched knowledge graphs with domain ontologies and metadata to connect colloquial terms with technical data elements. Such enrichment provides for execution of transformed query objects against an EDL's indexed dataset(s) to retrieve relevant information at a speed, accuracy, and ease that is impossible to match. Examples of the platform can present results to users in an easy-to-understand visualization with explanation liking to the original conversational query, for example. In further examples, the platform can enable voice-based inputs using automatic speech recognition to create a natural user experience to data searching. Such application of conversational querying can provide intuitive access to data and insights from the EDL using human-like interactions, allowing for an increased adoption across a broader community of business users (e.g., non-technical users, non-data analysts, non-IT users, etc.).

Additional examples of the present disclosure provide for analytics modules that apply techniques such as machine learning, artificial intelligence, and/or statistical modeling on enriched data in order to derive insights into customer journeys, interactions between customers and unrelated sectors of the financial institution, customer behaviors, patterns, trends over time, and more. This may include, for example, analyzing customer journey data across channels, touchpoints, products, and services associated with the financial institution to understand relationships and behavior. Models identify meaningful patterns and changes to enable data-driven decisions.

The present disclosure further provides for example embodiments that enable manual recurring reports to be automated by configuring workflows that pull the latest enriched data from the EDL on a scheduled basis. Parameters can be set to customize reports, and automated reports can be generated much faster than by manual analysis by data analysts, providing decision makers with access to more timely insights. For example, analytics can determine which characteristics, such as communication channels and times maximize customer engagement based on historical interactions and outcomes to identify optimal communication methodology for ensuring customer interaction with the financial institution. Channels may include physical locations, web sites, mobile applications, phone calls, emails, etc. Analytics identifies optimal customer contact strategies.

Example embodiments of the platform and/or application provide additional rule-based adherence to regulatory requirements (e.g., government regulations, societal considerations, financial institution rule compliance, etc.). For example, workflows incorporate domain-specific application functionality and decision rules that encapsulate core operational processes and data computations required to execute business transactions and workflows and to ensure compliance with regulations limiting customer contact frequency, such as number of calls per day or week. Contact attempts are tracked and rules trigger alerts on violations, where safeguards can be automatically implemented to prevent over-contacting customers. In some examples, customized financial data processing and augmentation layer can contain reusable modules, components, services, and other artifacts that implement critical business capabilities by performing actions such as executing process steps, transforming data, invoking external services, applying policies and rules, routing information, handling exceptions, emitting events, or a combination thereof. Well-structured industry-specific data modeling and enhancement can enable separation of concerns, manageability, and agility when adapting to evolving business and/or customer needs by providing, for example, a core application intelligence while maintaining independence from surrounding persistence, presentation, integration, or other architectural layers.

In addition, the present disclosure solves the technical problem of multiple user interfaces, wasted networking and computing resources inherent in accessing multiple different resource store systems to search, locate, aggregate, and/or analyze data by using the technical solution of presenting a single interface (e.g., platform and application) to search and view all customer and financial institution data across different systems. This provides for rapidly searching, accessing, processing, and analyzing information and increases the efficiency of a user interface by allowing the user to locate information of interest conveniently and rapidly. The disclosed techniques spare users of the time-consuming operations of navigating to, opening up, and then navigating within, each separate resource store's interface, as well as aggregating the disparate data. The disclosed techniques thus recite specific improvements to the way computers operate.

Example embodiments of the present disclosure can include providing a data collection, aggregation, and analytics platform that incorporates modular design principles and leverages capabilities such as business process modeling, domain-driven design, business rules engines, or the like to allow for the construction of flexible, testable custom processing algorithms tailored to the financial industry that serve as an authoritative system of record for core enterprise functions.

### Detailed Embodiments

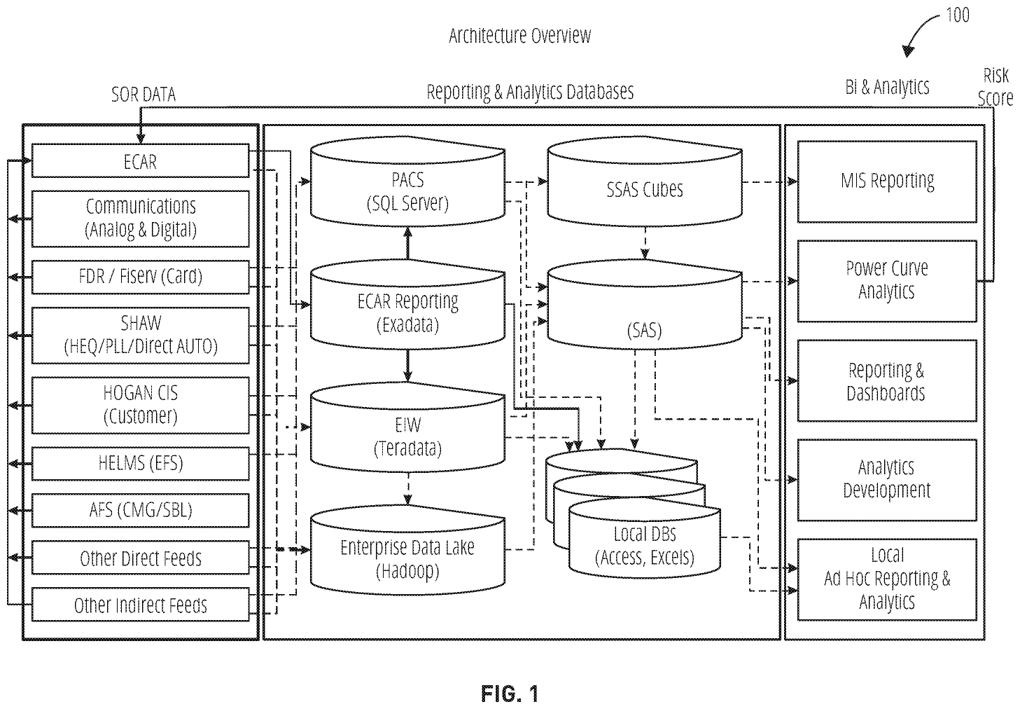

FIG. 1 is an example of a diagram 100 illustrating an existing (prior art) architecture overview of a reporting and analytics system including a plethora of data sources that are individually monitored and searched by professional data analysts. In such existing (e.g., current state) architectural examples, a skilled user, such as a data analyst or SQL programmer, could require individualized searching of over 60 data sources in order to identify relevant data. The acquired data is then duplicated to multiple separate analytical platforms, which lead to data quality problems and integrity issues.

As noted above, such existing systems fail to provide for a single information marketplace and are unable to understand (e.g., comprehend, make sense of, aggregate into categories, etc.) the data located in disparate sources.

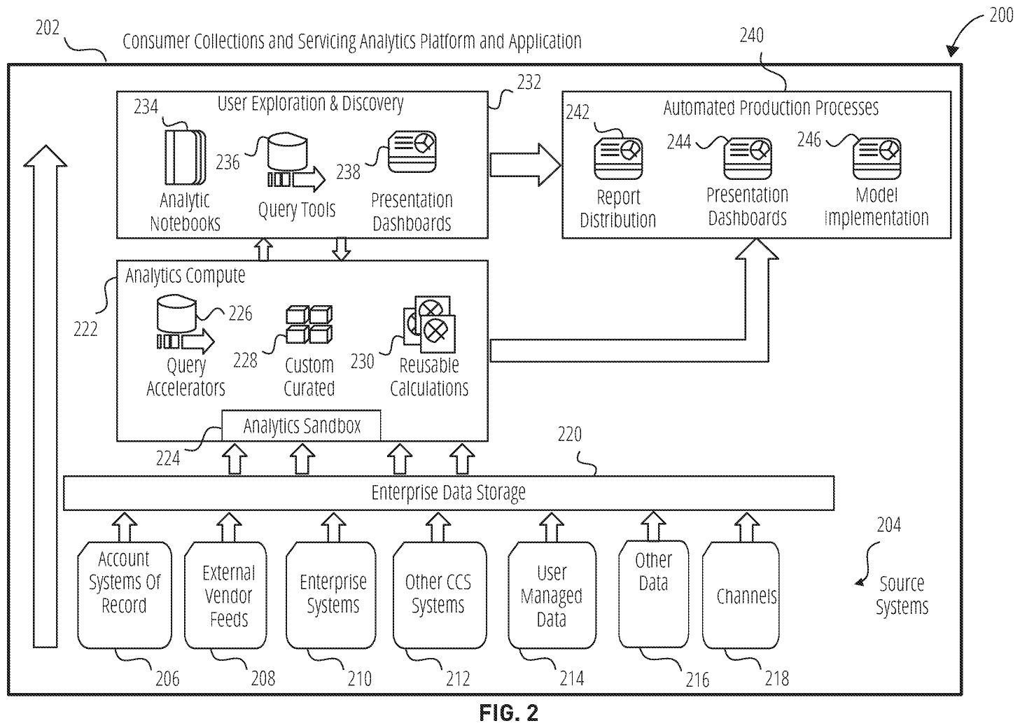

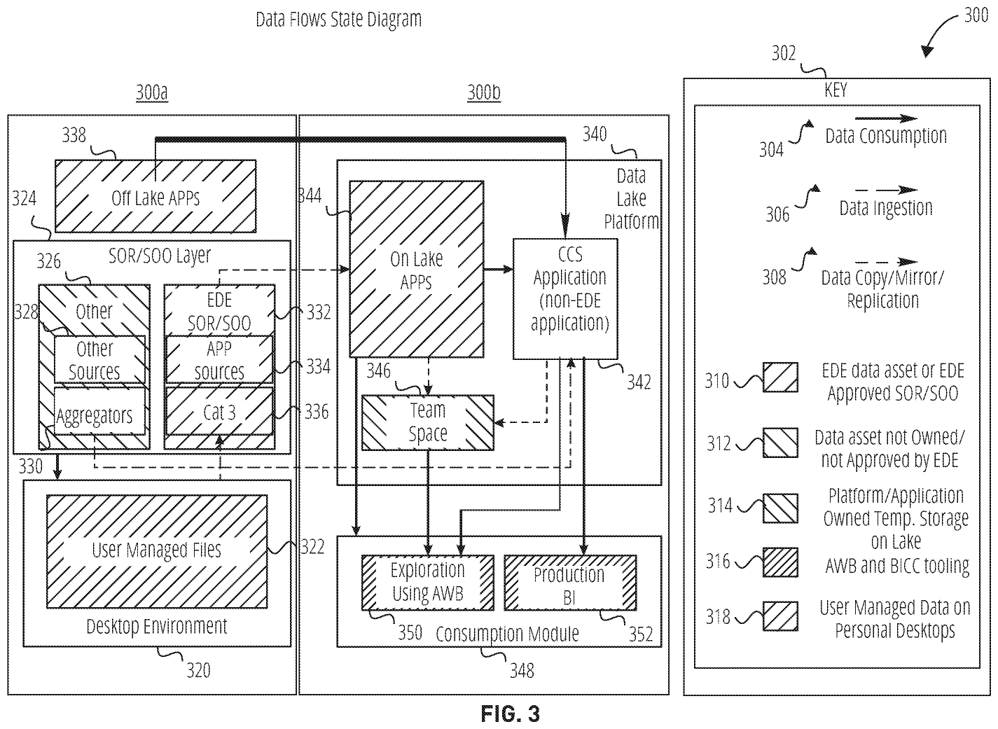

FIG. 2 is an example of a block diagram 200 illustrating aspects of the consumer collections and servicing analytics platform and application 202, according to an example embodiment. The block diagram 200 and accompanying description provides a general overview of the consumer collections and servicing analytics platform and application 202 according to one example embodiment. The consumer collections and servicing analytics platform and application 202 is further described and depicted in connection with FIGS. 3-9.

Example embodiments of the consumer collections and servicing analytics platform and application 202 can be implemented through or create by leveraging and extending an organization's existing enterprise data lake (EDL), analytics workbench (AWB), and business intelligence competency center (BICC) technology foundations. For example, the EDL can provide a scalable data repository consolidating raw, structured, and unstructured data from disparate sources into a centralized data hub. The AWB provides a collaborative analytics environment including data science toolkits, reusable models, shared services, and the like. The BICC established best practices for business intelligence (BI) solutions, including, for example, data governance, capability management, metadata management, and the like. Examples of the present disclosure combine and build upon these core platforms by aligning with architectural principles and enabling reuse of existing services, information assets, skillsets, and the like that are otherwise unconnected.

According to examples of this new solution, the consumer collections and servicing analytics platform and application 202 can inherit a hybrid cloud computing infrastructure, security protocols, management interfaces, and the like. By providing integration with core data ingestion, preparation, storage, and processing components that are otherwise disparate and/or unconnected, the consumer collections and servicing analytics platform and application 202 provides for an accelerated development and stack that includes foundational analytics, visualizations, reporting building blocks, and the like. Further examples include leveraging enterprise-grade technologies already adopted in isolation, the solution of the present disclosure can minimize time-to-value while lowering risks, maintenance overhead, and more. The consumer collections and servicing analytics platform and application 202 provides for a consolidated outcome that includes an enterprise-aligned analytics solution that capitalizes on current platforms combined in a manner that realizes synergies otherwise not found.

The consumer collections and servicing analytics platform and application 202 includes source systems 204. The source systems 204 can include, for example, an account system of record 206, external vendor feeds 208, enterprise systems 210, other CCS systems 212, user managed data 214, other data 216, channels 218, or other source systems 204. The data aggregated or otherwise sourced from the source systems 204 is then forwarded to the enterprise data storage 220 for additional data manipulation according to the consumer collections and servicing analytics platform and application 202. From the source systems 204, the information is transmitted to the enterprise data storage 220, which, in turn, passes the collected data to an analytics compute module 222 directly or via an analytics sandbox 224.

The analytics compute module 222 provides for a variety of customizable analytics options, such as a query accelerator(s) 226, a custom curated data module 228, a reusable calculations module 230, and the like. Data analytics computed by one or more processes of the analytics compute module 222 can be transmitted (e.g., passed) to an automated production processes module 240 for further data processing (described in detail below).

From the analytics compute module 222, example embodiments provide for multiple additional processes to be performed on the aggregated data. For example, the analytics compute module 222 can transmit to and receive information from a user exploration and discovery system 232, that includes analytic notebooks 234, query tools 236, presentation dashboards 238, and other exploration toolkits to review, characterize, and render data in a variety of outputs. The user exploration and discovery system 232 can pass analyzed and/or transformed data back to the analytics compute module 222 for additional processing and can pass analyzed and/or transformed data to an automated production processes module 240.

The automated production processes module 240 can include addition analytics and consumer collection tools, such as report distribution 242, presentation dashboards 244, model implementation 246, and the like. The consumer collections and servicing analytics platform and application 202 further provides for additional data actions, such as data consumption, data movement, data management, resiliency, disaster recovery, monitoring, logging, file transfer, CI/CD, and the like (described in more detail below). Additional examples can include a variety of model implementation, user-drive, self-ingestion to team spaces, user-driven path(s) to production, search, and natural language-based user self-analytics, providing that all CCS data is accessible and consumed, hybrid deployment models, and the like.

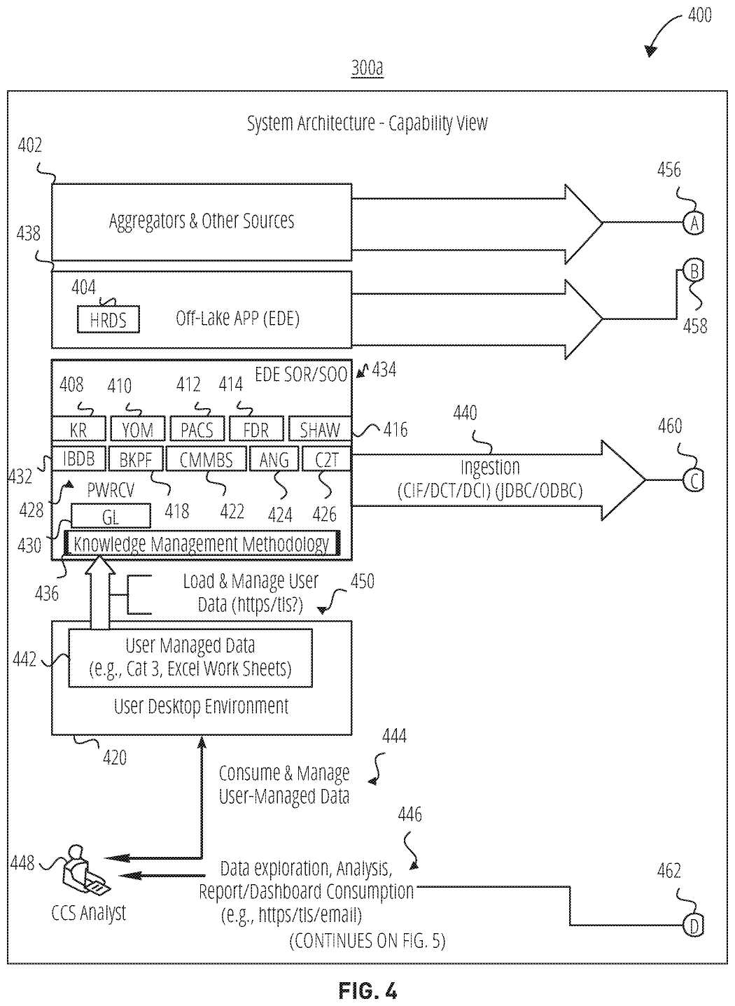

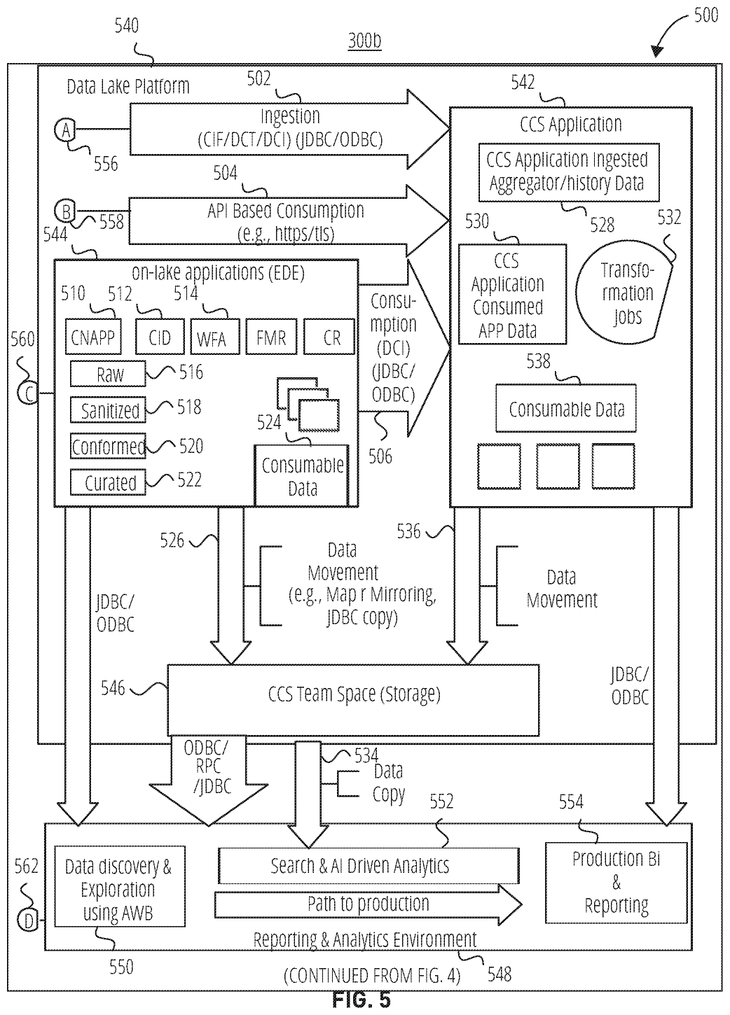

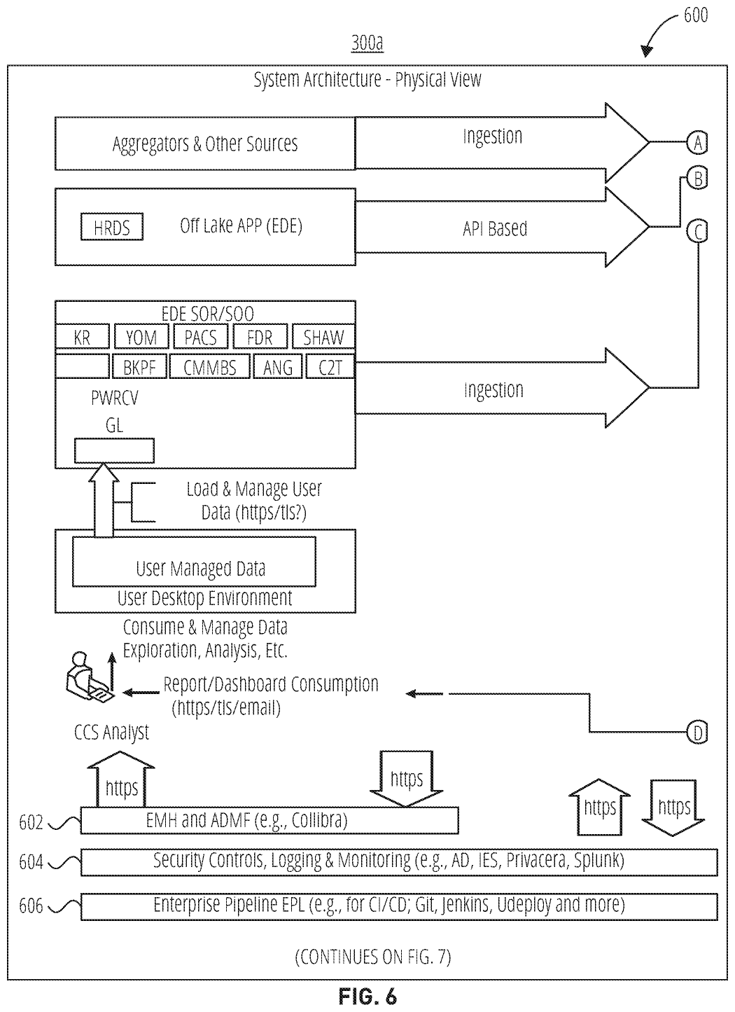

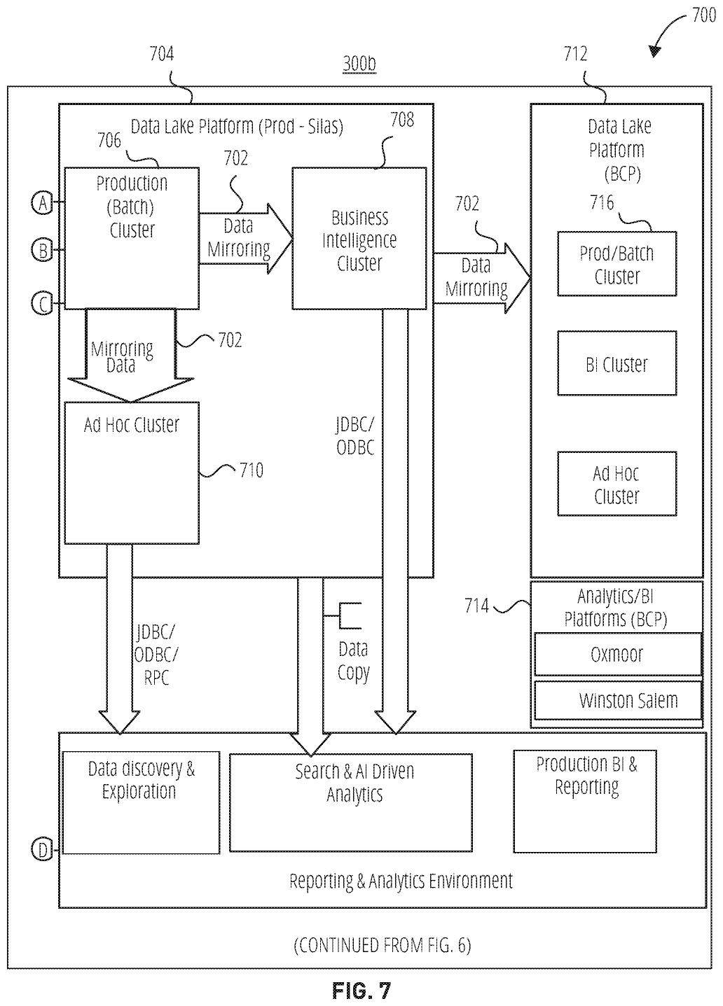

FIG. 3 provides an illustrative example of a data flows state diagram 300 of the consumer collections and servicing analytics platform and application, in accordance with some example embodiments. The data flows state diagram 300 shows how data is consumed, ingested, copied, and replicated according to examples of the consumer collections and servicing (CCS) application 342 that is created on an enterprise data lake platform (EDL) 340 for enabling custom and cross-domain data curations, historical data aggregation, and off-lake application data aggregation. For purposes of providing detailed illustration and components of the consumer collections and servicing analytics platform and application shown in data flows state diagram 300, the data flows state diagram 300 is identified, for exemplary purposes only, as consisting of 300a (details of which are further described and depicted in connection with FIGS. 4 and 6) and 300b (details of which are further described and depicted in connection with FIGS. 5 and 7). Where FIGS. 4 (300a) and 5 (300b) are viewed and described together, and where FIGS. 6 (300a) and 7 (300b) are viewed and described together.

The data flows state diagram 300 includes a key 302 that provides for data flows shown via arrows including data consumption 304, data ingestion 306, and data copying/mirroring/replication 308. The data flows include data consumption 304, data ingestion 306, and data copying/mirroring/replication 308 as shown throughout the data flows state diagram 300 and provide for data movement through orchestrated pipelines of the consumer collections and servicing (CCS) application and platform, which enables automation of otherwise time-consuming manual processes for near real-time analytics of the enriched data using one or more pipelines through the application and/or platform.

The key 302 further includes example embodiments of layers of the platform application created on an enterprise data lake (EDL) to employ off-lake data, custom curations, reusable calculations, and more. For example, the key 302 includes enterprise data environment(s) (EDEs) data asset or EDE-approved system, subsystem, object, and record (SOR) data and/or system, subsystem, and object (SOO) data 310, data asset not owned/not approved by EDEs 312, platform/application owned temporary storage on lake 314, Aggregated Workbench (AWB) and Business Intelligence Competency Center (BICC) tooling 316, and user managed data on personal desktops 318.

An Enterprise Data Environment (EDE) generally refers to the full set of data management capabilities that support an organization's information needs, including, for example, comprehensive capabilities required to manage, integrate, govern, secure, and enable business usage of data across an enterprise, providing the full environment to support an organization's information needs. Specifically, an EDE includes: data architecture providing models, policies, standards, and designs for managing data as an enterprise asset, covering relational, dimensional, and big data architectures; data integration capabilities for consolidating and managing data across disparate sources, including ETL, data virtualization, master data management, data federation, and more; data quality functionality for profiling, cleansing, matching, and monitoring data; metadata management for catalogs, dictionaries, lineage, and glossaries; data security controls for access, encryption, masking, and auditing; data governance programs, roles, and processes for oversight of data assets; and tools and platforms for accessing, analyzing, and reporting on data.

Turning to the detailed example flow of data in the data flows state diagram 300, starting with off-lake applications 338, data consumption 304 from the off-lake applications 338 enters the CCS application 342 on the data lake platform 340. According to examples of the present disclosure, the data lake platform 340 includes a centralized platform for aggregating disparate data sources to provide faster and more efficient data analysis for business users. The data lake platform 340 includes on-lake applications 344, a CCS application team space 346, and a CCS application 342 (e.g., non-enterprise data environment application). For example, the CCS application team space 346 can include a physical infrastructure that allows business data analysts or other users to rapidly prototype analytic solutions and perform ad-hoc analysis in a secured “container” (commonly referred to as an analytic sandbox).

According to some example embodiments, on-lake applications 344 and off-lake applications 338 can be used to acquire data. For example, on-lake applications 344 (e.g., analytics applications) are natively integrated into the enterprise data lake (EDL) environment (e.g., the data lake platform 340 and/or the CCS application 342), which enables direct data processing and analysis against raw, unstructured data stored in distributed file systems or object stores. By collocating analytical workloads within the data lake, on-lake applications 344 avoid the latency and complexity of extracting, transforming, and loading (ETL) large volumes of data into downstream platforms prior to analysis. On-lake applications 344 leverage scale-out, parallel processing frameworks (e.g., Apache Spark, Presto, etc.) to run analytical jobs across the data lake's native storage formats (e.g., Parquet, ORC, JSON, etc.). This provides interactive, ad-hoc analytics at low latency by data scientists and business users. On-lake applications 344 further enrich raw data into consumable, business-ready datasets, and data products while still within the data lake (e.g., the data lake platform 340). For example, some on-lake applications can include, customer intelligence (CN) applications, customer insight (CI) applications, financial market risk (FMR) applications, Credit Risk (CR) applications, and the like.

In the financial services industry, on-lake analytics applications are often used to gain insights into customer behaviors, transactions, trends, and patterns from large volumes of data stored in data lakes. Financial institutions leverage these on-lake analytics applications to make data-driven decisions that promote customer retention, new business growth, and risk management. According to examples of the present disclosure, the natively integrated processing of such on-lake applications 344 avoids the delays and complexity of moving large volumes of raw data to downstream platforms prior to analysis. For example, CI applications can focus on deriving granular insights about individual customers or households to improve personalization, marketing, and customer experience. Such as, analyzing spending patterns, life events, and demographics to offer tailored products or enhance service interactions. CN applications can provide a broader view of data to identify trends, segments, and opportunities across the entire customer base. For example, analyzing transaction flows to detect fraud, optimizing customer tiers and pricing, or identifying growth opportunities in certain customer profiles.

In an enterprise data environment (EDE) for a financial institution, managing financial market risk (FMR) is imperative for financial institutions with large investment portfolios exposed to fluctuations in market prices and rates. For example, FMR arises from trading, capital markets, treasury, and commercial banking activities. Key FMR exposure types (e.g., data) can include, for example, interest rate risk, equity risk, foreign exchange risk, credit spread risk, and the like. FMR represents a range of market price and rate fluctuation risks requiring sophisticated management in an EDE. Robust FMR management entails accurate measurement of risk exposures using sensitivity analysis, value-at-risk models, scenario analysis, and stress testing. For example, active hedging of exposures within risk limits using derivatives like swaps, futures, and options is key. As well as, ongoing monitoring, reporting, and independent oversight, price verification, valuation adjustments, and prudent collateral management being essential. With the advanced analytics and automation of the CCS application 342 according to example embodiments, financial institutions can better understand and mitigate FMR to operate sustainably.

Additionally, in an EDE for a financial institution, assessing and managing credit risk (CR) is a core competency to provide lending products like credit cards, lines of credit, auto loans, mortgages, and the like. Key activities for CR can include evaluating the creditworthiness of applicants using data like credit bureau information, income and collateral verification, modeling, scoring, and more in order to determine approval and credit terms. Financial institutions also establish credit limits, interest rates, and risk-based pricing aligned to risk appetite, with less risky borrowers potentially qualifying for larger limits or lower rates. On-lake applications 344 can be used to monitor portfolio concentrations by exposure types, risk ratings, geographic segments, and other factors helps avoid correlated defaults, detect early warning signs of deteriorating credit health allows proactive mitigation, report credit exposures, risk metrics, and trends to executives and regulators is another important activity, and forecast expected credit losses and capital requirements informs sound business decisions, while performing stress testing determines capital adequacy in adverse economic scenarios. By using CR on-lake applications 344 to consume data into the CCS application 342, robust data, models, analytics, and/or automation can be performed by financial institutions to accurately measure credit risk and monitor it in real-time.

In contrast to the on-lake applications 344, off-lake applications 338 generally reside on separate analytic databases, data warehouses, and data marts that have transformed and loaded data through traditional ETL processes. Off-lake analytics can rely on predefined schemas and Online Transaction Processing systems requiring upfront data preparation. The separation of off-lake applications and/or systems introduces delays for batch data movement and restructuring (off-lake applications 338 are further described and depicted in connection with FIG. 4).

Returning to the data lake platform 340, the platform 340 provides an integrated suite of technologies and services that allow full lifecycle management of enterprise data lakes, spanning infrastructure, ingestion, preparation, governance, security, orchestration, and analytics. The data lake platform 340 delivers managed scale-out storage and computing along with capabilities to automate the cataloging, organization, and refinement of raw data into consumable, analysis-ready datasets. Additional examples of the data lake platform 340 can further incorporate access control, usage monitoring, and data protection while enabling integration with downstream data science, analytics, and visualization tools through low-code access methods. As previously noted, a data lake constitutes a centralized data repository for storing vast volumes and varieties of structured, semi-structured, and unstructured data in native formats using scalable, low-cost object or distributed file storage systems. Generally, data lakes support high-throughput raw data ingestion and batch processing without requiring predefined schemas prior to data intake. However, additional mechanisms must be implemented to enable metadata management, data governance, security controls, and effective data preparation and organization (additional details described and depicted in connection with FIG. 6). While a data lake provides raw data storage and batch processing, the data lake platform 340 incorporates the comprehensive capabilities required to maximize the business value of data lakes through simplified data management, governance, and analysis.

According to examples of the present disclosure, the CCS application 342 on the data lake platform 340 receives data from all applications, objects, and layers via data consumption 304, data ingestion 306, and/or data coping/mirroring/replication 308. For example, the CCS application 342 consumes data 304 from the off-lake applications 338, ingests data 306 from one or more data assets not owned or not approved by the EDE 312, and copies/mirrors/replicates data 308 from the on-lake applications 344. The on-lake applications 344 ingest data 306 from the EDE SOR/SOO 332, such as application sources 334 and/or Category 3 data (Cat 3 data) 336, which, in turn, ingests data 306 from a desktop environment 320. For example, Cat 3 data 336 can be a category or classification of data within user managed data tools and frameworks, such as user managed files 322, and generally refers to data that is shared across groups/departments within an organization, data that is considered sensitive business data, data with moderate security, privacy, or compliance requirements, and/or data that is regulated in some way, such as personally identifiable information (PII) or financial data.

Specifically, the EDE SOR/SOO 332 data sources can be located on a SOR/SOO layer 324, which also includes other data assets 326 that are data assets not owned and/or not approved by the EDE 312. The SOR layer refers to the full System/Subsystem, Object, and Record categorization structure in the SOR data methodology. Specifically, the SOR layer encompasses the entire hierarchical taxonomy for organizing data elements, which can include the System layer representing the top-level subject area like finance or inventory, the Subsystem layer breaking the System down into components like accounts receivable, the Object layer further dividing the Subsystem into specifics like invoice, and the Record layer containing the actual data attributes like invoice number, date, amount, etc. The SOR layer establishes standardized definitions and consistent usage of data across applications. It provides inheritance of attributes down the structured levels, giving full context and relationships for organizing information. The System, Subsystem, and Object layers handle the broad categorization and linkage of related data, while the Record layer stores the discrete data elements. In summary, the SOR layer refers to the complete hierarchical taxonomy encompassing the System, Subsystem, Object, and Record categorizations in SOR methodology that models the full context and structure for organizing data elements into a standardized framework.

In contrast to the SOR layer, the system, subsystem, and object (SOO) layer establishes the hierarchical taxonomy for data context. It handles the broad categorization and linkage of related information, which allows common attributes and metadata to be inherited down the structured levels. It enables standardized definitions and consistent usage across applications. The SOO layer provides the abstract framework to give these data records their full meaning and usage. For example, the SOO layer encompasses the higher levels of categorization related to the System, Subsystem, and Object groupings, which provides the overall structure and relationships for organizing data elements (e.g., representing the top-level subject area like finance or inventory). For example, in the SOO layer, the subsystem breaks the system down into components like accounts receivable, the object further divides the subsystem into specifics like invoice.

For example, the other data assets 326 on the SOR/SOO layer 324 can include other sources 328, aggregators 330, and the like. Data from the other data assets 326 (e.g., data assets not owned and/or not approved by the EDE 312) can be consumed by the desktop environment 320 via data consumption 304. Additionally, data from the aggregators 330 can be copied, mirrored, and/or replicated from the aggregators 330 to the CCS application 342 on the data lake platform 340.

From the data lake platform 340 generally, and the on-lake applications 344, the CCS application 342, and the team space 346 specifically, data can be sent to the consumption module 348 to be consumed 304 by an exploration tool using an Aggregated Workbench (AWB) 350, a production business intelligence (BI) tool 352, or the like. For example, the data consumption module 348 can include or be a part of a reputing and analytics environment described and depicted in more detail in connection with FIG. 5.

The data flows state diagram 300 is divided into two sections 354 (left side of system) and 356 (right side of system) for ease in description. Specifically, the left side of the system 354 architecture is further described and depicted in detail in connection with FIGS. 4 and 6 and the right side of the system 356 architecture is further described and depicted in detail in connection with FIGS. 5 and 7.

FIG. 4 illustrates a block diagram 400 including a capabilities view of the left side of the system 354 architecture that is continued in FIG. 5, in accordance with one embodiment.

The aggregators and other sources 402, such as the aggregators 330 and the other sources 328 of data assets not owned and/or not approved by the enterprise data environment (EDE) as described and depicted in connection with FIG. 3, pass data via A 456 to A 556 in FIG. 5.

The off-lake applications 438, such as any enterprise data environment (EDE) applications, pass data via B 458 to B 558 in FIG. 5. For example, some off-lake applications can include the Human Resources Data Store (HRDS) 404, which contains employee data integrated from various human resource (HR) operational systems to enable centralized reporting, analytics and dashboards for workforce planning, cost optimization, retention, recruitment, compensation analysis, and other workforce management functions. Therefore, while on-lake applications generally achieve greater agility, lower latency, and reduced data replication by analyzing data within the enterprise data lake, the off-lake applications 438 can provide value additional value that is otherwise unreachable by current systems. According to examples, organizations (e.g., financial institutions) can employ a hybrid strategy using the optimal approach based on integration, performance, and governance considerations using a CCS application on the data lake platform to use off-lake data (e.g., data received from off-lake applications 438), custom curations, and reusable calculations, while continuing to support user managed data.

Returning to the system architecture in block diagram 400, the EDE SOR/SOO 434 data sources, such as the EDE SOR/SOO 332 as described and depicted in connection with FIG. 3, can include a variety of systems, procedures, records, reports, or other disparate data sources relevant to financial institutions in an enterprise data environment.

The EDE system, subsystem, object, and record data (SOR) data in EDE SOR/SOO 434 refers to a method of organizing data elements into systematic categorizations of System, Subsystem, Object, and Record to provide structure and context. This methodology carefully organizes information into hierarchical groupings (e.g., systems, subsystems, objects, and records). System refers to the overall subject area, like finance or inventory. Subsystem is a component within the system, like accounts receivable. Object further breaks down the subsystem, like invoice. Record contains the specific data attributes, like invoice number, date, amount. SOR allows inheritance of properties down the hierarchy and enables standardized definitions and metadata to be applied, and it facilitates data governance, security, quality control, and supports data modeling for databases and software applications. SOR data methodology categorizes information into layered levels: system, subsystem, object, and record which provides standardized structures, relationships, and context for computerized data and systems. The SOO data in the EDE SOR/SOO 434 provides the SOR data records their full meaning and usage.

For example, the EDE SOR/SOO 434 for a financial institution can include, for example, key resources (KR) 408, year of manufacture (YOM) 410 in which an asset was produced, predictive analytics for credit risk (PAC) 412 applications, a final design review (FDR) 414 evaluation, a safety hazard analysis worksheet (SHAW) 416, an integrated budget database (IBDB) 432, a bank file (BKPF) 418 record, a capital asset management and budgeting system (CMMBS) 422, an accounts receivable aging (ANG) report 424, a command and control terminal (C2T) 426 workstation, and hundreds of other data sources. The EDE SOR/SOO 434 can further include, for example, a power recovery (PWRCV) 428 system encompasses the resilience capabilities to handle power disruptions with minimal impact to critical business operations and a general ledger (GL) 430 repository. Each of the variety of data sources illustrated in the EDE SOR/SOO 434 is described in brief to provide details of the importance of just a few financial institution resources that come from disparate sources.

In an enterprise data environment for a financial institution, the term key resource (KR) 408 refers to critical human capital assets; specifically, key resources are employees within the organization who possess specialized skills, knowledge, and capabilities that are deemed essential to executing the core business strategy and operations. Common examples of key resources may include top revenue-generating roles such as investment bankers and financial advisors; critical risk management roles like credit underwriters; and niche experts in areas like quantitative modeling, cybersecurity, and regulatory compliance. For example, within EDEs in financial services, KR 408 is a designation for the elite talent that is imperative for an organization to compete and thrive in its markets.

Within enterprise data systems the data element YOM 410 provides key temporal context for effective utilization and governance of organizational assets and liabilities. For example, capturing the YOM 410 is essential for asset inventory management, valuation, depreciation calculations, and maintenance planning. From a regulatory compliance perspective, YOM provides supporting detail for required financial reporting related to depreciation.

Many financial institutions leverage on-lake analytics to develop predictive models for assessing credit risk. A common application is PAC 412, which utilizes advanced algorithms to analyze customer data and make data-driven predictions about the creditworthiness of borrowers or counterparties. The predictive insights from PAC applications can assist financial institutions with critical risk management functions including approving loans, setting credit limits, and optimizing lending portfolios. By performing PAC on data lakes, example embodiments avoid unnecessary ETL overhead and leverage scalable on-lake compute for feature engineering and model training on large data volumes.

In an enterprise data environment, the FDR 414 refers to a formal evaluation conducted to assess the readiness of a new product, system, or process for launch and implementation. The FDR represents the final stage of design verification before transitioning to production rollout and adoption. Key stakeholders from business units, technology teams, risk management, and governance functions are assembled to scrutinize all aspects of the pending launch. The FDR validates alignment to budget, timeline, compliance, and strategic objectives.

The SHAW 416 refers to a risk management tool used to identify, assess, and control occupational hazards and unsafe conditions. The SHAW provides a structured methodology to analyze work environments, tasks, equipment, and processes to uncover and evaluate safety risks. Cross-functional teams systematically review facilities, operations, and behaviors through the lens of potential accidents, injuries, or health impacts. The SHAW 416 is a core component of enterprise risk management programs at financial institutions, enabling proactive safety practices to protect employees, contractors, and the public. By including such disparate data in the CCS application according to example embodiments, any user, whether part of such a cross-functional team or not, can access, search, and analyze the SHAW data in a centralized repository.

The BKPF 418 refers to a record containing detailed information on a specific bank. The BKBF is part of a master data management system that aggregates reference data on financial institutions that have a relationship with the enterprise. For example, the BKBF stores key attributes including the bank's name, physical address, phone number, website URL, and SWIFT code. It captures the bank's regulatory status, credit rating, and primary financial market. The BKBF lists the names and contact information for key decision-makers at the bank. It tracks the enterprise's accounts, transactions, and services associated with the bank. For example, the BKBF is an essential master data construct within financial institutions' enterprise data environments.

The CMMBS 422 is an integrated software platform that enables oversight of capital expenditures and fixed assets. For example, the CMMBS compiles budget requests, project proposals, and purchase requisitions from across business units into a centralized repository. Built-in workflow automation routes proposed capital spending through approval chains to validate alignment with strategic priorities and budget availability. By including the CMMBS 422 into the integrated and centralized CCS application, it provides financial institutions with an auditable system of record for capital asset lifecycle management, budgeting, procurement, and reporting.

The ANG report 424 is a critical financial report for banking and lending organizations that summarizes the status of outstanding receivables by age category, such as current, 30 days past due, 60 days past due, and 90+ days past due. For example, the ANG report allows banks to monitor the health of receivables, watch for signs of delinquency, and inform bad debt reserve levels. It provides visibility into potential liquidity and cash flow issues if receivables become excessively aged.

In an enterprise data environment for a financial institution, the C2T 426 refers to a dedicated workstation with access privileges to execute sensitive commands, queries, and transactions on critical production systems. The C2T enables authorized users like database administrators, system operators, and cybersecurity analysts to perform operational management, troubleshooting, maintenance, and security monitoring. By incorporating simplified searching, aggregation, compilation, and analytics of the C2T data, the CCS application and platform can provide for valuable data in a centralized point of access.

The IBDB 432 refers to a centralized platform for budget data consolidation, reporting, and analytics. The IBDB compiles budget and forecast information from across business units, departments, and cost centers into a unified repository. On its own, as a stand-alone data source, the IBDB provides finance teams enhanced visibility into projected expenditures for compensation, operations, technology, facilities, marketing, and other costs. By incorporating the IBDB data into the CCS application/platform, it integrates actual spending data from source systems like accounts payable, enabling monitoring of budget versus actual variance. Built-in financial reporting and analytics capabilities help inform business planning, cost optimization, and resource allocation decisions. The IBDB improves the accuracy, agility, and auditability of the budgeting process through systematized controls, workflows, and standards. Version control within the IBDB creates an auditable record of budget revisions and security protocols restrict access to authorized finance users only, but the data can be aggregated, incorporated, and analyzed for easy searching via the CCS application.

The GL 430 is the central repository for recording, categorizing, and reporting financial transactions. The GL produces account balances, statements, and analytics through flexible reporting capabilities. Normally, a segregation of duties restricts access to authorized accounting staff, and audit trails capture all GL modifications. For accuracy and transparency, GL account data is reconciled with subledger transactions, and the centralized, controlled GL acts as a system of record for legal and regulatory financial reporting. The GL is the backbone of the accounting infrastructure which maintains authoritative financial data for internal and external stakeholders in a financial institution. By combining GL data into the CCS application/platform according to example embodiments, the GL data can be aggregated in a searchable format in a centralized repository while ensuring restrictions and authorizations.

Any data from the variety of systems, procedures, records, reports, or other disparate data sources relevant to financial institutions in an enterprise data environment as depicted in FIG. 4 and other data sources applicable to online banking or financial institutions can be incorporated into the EDE SOR/SOO 434 and forwarded for ingestion 440 via C 460 to C 560 in FIG. 5. Data ingestion, such as ingestion 440, refers to bulk loading of large data volumes from source systems into a target database or data warehouse. The data ingestion 440 can be performed using standard interfaces, connectors, drivers, and formats used during the data ingestion process to efficiently extract data from sources and load it into the target system, such as the CCS application, typically using standard interfaces like CIF, DCT, DCI, JDBC, ODBC that are optimized for high-throughput data transfer. Common Ingestion Format (CIF) is a standardized data format for ingesting data into data lakes and warehouses. Allows for schema flexibility and efficient serialization/deserialization. Data Connector Technology (DCT) refers to components used to connect source systems with target ingestion platforms and move data between them. Includes connectors, drivers, APIs, etc. Data Connector Interface (DCI) is an interface that defines common connectivity and data transfer operations for data connectors, allowing interchangeability. Java Database Connectivity (JDBC) is a Java API for connecting to databases and executing queries. Used for ingesting data from RDBMS sources. Open Database Connectivity (ODBC) is a standard API for connecting to database management systems and performing CRUD operations. Used for ingestion from OLTPs.

Returning to the EDE SOR/SOO 434, user-managed data can be supported using a knowledge management methodology 436, such as Knowledge Information Management Benefit Analysis (KIMBA), used to identify, quantify, and prioritize potential benefits of implementing knowledge management practices and technologies in an organization. The knowledge management methodology 436 involves analyzing knowledge gaps, opportunities, stakeholders, etc., while leveraging application data both on-lake and off-lake, leveraging the EDL ecosystem's technical and business capabilities (e.g., DCT, AWB, BICC, etc.), and more.

The knowledge management methodology 436 module of the EDE SOR/SOO 434 can receive (e.g., load, manage, etc.) user data 450 from a user managed data 442 source, such as Cat 3, Excel worksheets, and the like, stored on a user desktop environment 420. For example, Cat 3 data represents a moderate security classification for regulated, sensitive, or proprietary data shared across an organization. It requires more security measures than basic internal data but less than highly confidential data. For example, Cat 3 data can be a category or classification of data within user managed data tools and frameworks, such as user managed data 442, and generally refers to data that is shared across groups/departments within an organization, data that is considered sensitive business data, data with moderate security, privacy, or compliance requirements, and/or data that is regulated in some way, such as personally identifiable information (PII) or financial data. As Cat 3 data requires more security controls and governance compared to less sensitive Category 1 data, but not as much as extremely sensitive Category 4 data. Implementing appropriate controls and access restrictions for Cat 3 data is important for regulatory compliance and protecting sensitive enterprise information.

User-managed data is consumed and managed 444 between the user desktop environment 420 and a user, such as a CCS Analyst 448. In addition, the CCS Analyst 448 receives Data exploration, analysis, report/dashboard consumption 446 data via D 462 from D 562 in FIG. 5.

FIG. 5 illustrates a block diagram 500 including a capabilities view of the right side of the system 356 architecture that is continued from FIG. 4, in accordance with one embodiment. FIG. 5 is similar in many respects to FIG. 4, sharing certain similar features and components. For brevity, only specific elements are detailed and described with reference to FIG. 5.

Data received at A 556 from A 456 in FIG. 4 is ingested 502 into the CCS application 542 according to data ingestion methodology as described in FIG. 4. These move raw data in batches into a landing zone for further processing. Ingestion is suited for bulk periodic ETL workloads like an end-of-day snapshot of transactions because it can handle diverse formats, transformations, and loading into various targets. Ingestion provides robustness and recoverability for mission-critical data integration in financial institutions.

Data received at B 558 from B 458 in FIG. 4 is consumed by the CCS application 542 via application programming interface (API) based consumption 504, which represents a different approach for importing data into an enterprise data environment at a financial institution. API based consumption 504 refers to real-time or near real-time data access via application programming interfaces like HTTPS, TLS, etc., which allows point queries to fetch updated data on demand rather than batches. For example, APIs enable bidirectional requests and responses for applications to connect to databases and microservices. This is optimal for transactional systems needing low latency access to constantly changing data, often across internal services. APIs have less overhead than ingestion and allow seamless data sharing between systems. The different forms of data transfer into the CCS application 542 provide for ingestion, which handles high volume batch loading while API based consumption enables real-time access between systems in financial institutions. The approach is selected based on the integration and consumption needs for the enterprise data environment.

In an enterprise data environment (EDE) for a financial institution, on-lake applications 544, such as on-lake applications 344 as described and depicted in connection with FIG. 3, can receive data via C 560 from C 460 in FIG. 4 using the optimized data ingestion technologies detailed with respect to ingestion 440 allows for high-throughput bulk data transfer. The data ingested into the on-lake applications 544 of the data lake platform 540 can be received as raw 516 data, sanitized 518 data, conformed 520 data, curated 522 data, or other consumable data 524. In an enterprise data environment for a financial institution, there are different types of data that serve distinct purposes. For example, raw data refers to the original, unprocessed source data that is captured from transactional systems, interactions, and other sources; raw data exists in disparate silos across the organization and lacks context. Sanitized data is raw data that has been cleansed by removing incomplete, incorrect, inaccurate, and corrupt records through validation, standardization, and deduplication processes. Conformed data is sanitized data that has been structured into consistent formats, definitions, and values across systems through ETL processes and data governance policies, which enables unified analytics. Curated data is conformed data that has been enriched, aggregated, and packaged to serve specific use cases or users. It provides contextualized information tailored to business needs. Consumable data refers to curated data that has been modeled, visualized, and exposed through reports, dashboards, APIs, and other interfaces in a user-friendly way for easy consumption by business users and applications. It has been optimized for usability. Raw data gets transformed through incremental steps of sanitization, conforming, curation, and modeling to create consumable data that drives insights and decisions for financial institutions.

In addition to the ingested data formats, the on-lake applications 544 can receive data directly. For example, the ingested data can be passed directly to an on-lake application like the cloud-native application platform (CNAPP) 510, the customer identification number (CID) 512, the wealth and financial advisory (WFA) 514 application, or the like. The CID 512 is used to uniquely identify each customer. The CID 512 is a unique and persistent master identifier used to distinguish customers throughout their relationship lifecycle within the financial institution's enterprise data environment. Maintaining CID integrity is crucial for accurate customer data and transactions. The CID is generated when a new customer account is opened and persists as a permanent identifier throughout the lifetime of the customer relationship. The CID connects the customer profile across all systems, products, channels, and interactions; it distinguishes each customer from millions of other customers that a large financial institution serves. The CID may be an integer or alphanumeric code that is optimized for performance, storage, and reporting; it could incorporate attributes such as geography or customer type constraints. Integrating the CID into all downstream systems via APIs or batch transfers ensures consistency. Proper controls and masking secure the CID in test/development environments.

As financial institutions seek to broaden customer relationships, many now offer wealth management, investments, financial planning, and personalized advisory services. Delivering tailored WFA services requires aggregating customer data across banking, lending, investment accounts, insurance, retirement plans, and other offerings to form a consolidated view of assets, liabilities, net worth, holdings, and transactions. Customer analytics leveraging demographics, behaviors, life events, and propensities help segment and predict needs. Financial planning algorithms and simulations enable scenario analysis for cash flow forecasting, retirement readiness, education funding, and more. Portfolio analytics drive optimization, rebalancing, and risk analytics at both individual and aggregate levels. Advisory workflow tools handle onboarding, research, recommendations, relationship pricing, compliance supervision, and reporting.

The CNAPP 510 provides a suite of managed services to develop, deploy, run, and monitor cloud-native applications. For example, developers can quickly build applications using CNAPP's application frameworks, containers, microservices, and API gateway, in order to manage provisioning, balancing, auto-scaling, and availability of containerized application components across distributed cloud resources. Built-in monitoring provides observability into resource utilization, application performance, errors, and logs. CNAPP streamlines the continuous integration and delivery of updates; it enforces consistent security, compliance, and infrastructure policies across applications and environments. By leveraging CNAPP 510 into the CCS application 542, it enables financial institutions to accelerate cloud-native application development while maintaining control over critical data.

From the on-lake applications 544, data is consumed into the CCS application 542 via data consumption 506. For consumption, typical methods are REST APIs that enable CRUD operations over HTTP, GraphQL for flexible declarative data fetching, web-hooks for push-based HTTP callbacks triggered by events, gRPC remote procedure calls for high performance bi-directional streaming, and data services exposing reusable interfaces through a service-oriented architecture. The optimal choice depends on the specific integration, performance, scalability, and flexibility needs of the enterprise architecture. The key is aligning the ingestion and consumption approaches to the goals and constraints of the financial institution's data environment.

According to example embodiments of the present disclosure, once data is ingested, consumed, or otherwise processed into the CCS application 542, the CCS application 542 can further ingest aggregated and/or historical data 528 and compare it to CCS application consumed application data 530. The ingested and consumed data can be further processed by a transformation jobs 532 module of the CCS application in order to provide for data transformation, such as converting, sharing, and parsing data into a required format to make the received data CCS consumable data 538.

According to some examples, the CCS consumable data 538 is further processed according to one or more data analytics and intelligence systems. For example, the CCS consumable data 538 in an EDE for a financial institution, can be processed according to a MAPR F.S., which refers to Market, Analytics, and Product Research functions and systems. As financial institutions operate in an increasingly competitive and complex marketplace, leveraging data and analytics for market intelligence, customer insights, product innovation, and sales enablement is crucial. The CCS consumable data 538 can be further processed by large-scale data processing and analytics systems (e.g., HIVE) in order to leverage big data technologies and ecosystem tools to provide distributed storage of large volumes of transactional, interaction, reference, and unstructured data across commodity servers, delivering scalability and redundancy. As financial institutions accumulate vast amounts of structured and unstructured data across businesses and functions, parallel processing of data queries and workloads across clusters is faster and cheaper than legacy systems, while schema-on-read flexibility allows analyzing data without predefined schemas, facilitating exploration.

According to the block diagram 500, consumable data 524 and/or CCS consumable data 538 is moved to the CCS team space 546, via data movement 526 and CCS data movement 536 (e.g., mirroring, copying, etc.). For example, the CCS team space 546 can include an infrastructure that acts as a sandbox for business data analysts to prototype solutions, allowing analysts to change data if needed. Additionally, the team space 546 can include storage space that is used to save physical analytics data result sets, where analysts join disparate data together to identify patterns and trends across financial institution products, customers, and business operations processes.

In order to further process data according to example embodiments of the consumer collections and servicing analytics platform and application, data is transferred, consumed, copied 534, or otherwise moved from one or more of the on-lake applications 544, the CCS team space 546, or the CCS application 542 to the reporting and analytics environment 548 for further processing, analyzing, and reporting. For example, data is ingested into the data discovery and exploration 550 directly from the on-lake applications 544, data is copied 534 from the data lake platform 540 to the search and AI driven analytics 552 module, data is ingested into the reporting and analytics environment 548 from the CCS team space 546, and/or data is ingested into the production BI and reporting 554 module directly from the CCS application 542.

According to examples, the search and AI-driven analytics 552 can be leveraged in financial reporting and analytics environments to rapidly uncover insights from both structured and unstructured data. For example, search relevance can be enhanced through natural language processing (NLP) and machine learning (ML) algorithms, beyond keyword search, conversational interfaces like chatbots provide intuitive access to financial data. AI techniques like machine learning, neural networks, and natural language processing are applied directly on top of enterprise data platforms to power intelligent analytics apps, find patterns, predict outcomes, optimize decisions, and generate insights.

Once data is received at the reporting and analytics environment 548, a user-driven path to production is created as a functionality from the data discovery and exploration 550 using aggregated workbench (AWB) to a production business intelligence (BI) and reporting 554 modules (e.g., Tableau). The reporting and analytics environment (RAE) 548 can include a data discovery and exploration service for managing data analytics for real-time or near-real-time analysis on large volumes of data streaming from applications, websites, IoT devices, and the like. The explorer ingests, stores, and indexes telemetry and log data at massive scale and makes this data available for immediate analysis with built-in visualizations, analytics, and AI capabilities. According to example embodiments, reporting can be augmented with predictive capabilities, in a manner that users (e.g., analysts) can go beyond slicing and dicing historical data to gain forward-looking insights using AI. For example, machine learning models can analyze customer transactions, account history, and market data to generate personalized product recommendations and optimize targeting. Using the search and AI driven analytics 552 or other aspects of the reporting and analytics environment 548, financial institutions can empower employees at all levels with self-service access to data, make data-driven decisions faster, and improve operational efficiency.

The data discovery and exploration 550 including use of the AWB provides business users with self-service data access, preparation, analytics, and collaboration capabilities on top of aggregated data platforms at financial institutions. It empowers users to tap into unified enterprise data without IT bottlenecks, requiring data programming knowledge (e.g., SQL, MySQL, etc.), or otherwise having the user be a specialized data analyst. The AWB integrates with data aggregation pipelines and leverages augmentation technologies like AI/ML, NLP, and graph analytics to enhance self-service for users of all skill levels, hierarchies, or the like. For example, users can search and discover data, blend internal and external data, and automatically generate insights using augmented analytics. Collaboration features allow groups of users to securely discuss and share insights from data. Interactive workspaces support annotations, discussions and storytelling around analytics visualizations and reports. Governance capabilities in the AWB log, monitor and audit user activities to maintain security, privacy, and compliance over data. Usage patterns are analyzed by AI to identify risky behaviors. Data masking and filtering techniques prevent unauthorized access. By providing intuitive, governed self-service access to aggregated data, the AWB in the data discovery and exploration 550 breaks down silos and unlocks productivity across the financial institution. For example, business users can have on-demand access to trusted data and intelligence for faster, better decisions that drives improved business performance without compromising on governance.

Output from any module of the reporting and analytics environment 548 is passed to the user, such as the CCS Analyst 448 of FIG. 4, via D 562 to D 462, providing the user with data exploration, analysis, reports, dashboards, and/or other processed, aggregated, analyzed, or refined data for easy access and use.

FIG. 6 illustrates a block diagram 600 including a capabilities view of the left side of the system 354 architecture that is continued in FIG. 7, in accordance with one embodiment. FIG. 6 is similar in many respects to FIG. 4, sharing certain similar features and components. For brevity, only specific elements are detailed and described with reference to FIG. 6.

The Enterprise Message Hub (EMH) 602 is a core infrastructure component of financial institution data aggregation platforms. The EMH 602 serves as a centralized message broker enabling asynchronous messaging between disparate systems, which provides a scalable, fault tolerant, and secure message bus based on open technologies (e.g., Apache Kafka). The EMH decouples systems using common messaging patterns like publish-subscribe, message queues, and request-reply. For example, applications can publish messages to topics that are durably stored and asynchronously consumed by users. This real-time, event-driven architecture allows aggregation processes to ingest high volumes of transactional data published from source systems like core banking, payments, lending, and trading platforms.

According to some examples, the EMH 602 can further include an automated data management framework (ADMF) for metadata, data quality, lineage, data cataloging, or other data management needs. Using the EMH 602 module, a level of data catalog and business metadata can be defined and stored (e.g., Collibra) so that the business users (e.g., CCS Analyst 448) can easily understand their data. Physical data elements (PDEs) created as part of technical metadata can be mapped with business metadata and stored along with it in a data governance software platform to catalog, govern, and standardize data in the aggregation system, so that the users can easily find the data. For example, details captured can include data definitions, structures, lineage, owners, flows, security classifications and policies, which provides visibility into data assets. In additional examples, the data mapping can include interactions between a customer of the financial institution and a communication channel of the financial institution.

The data is further monitored, controlled, and/or logged according to a security controls 604 module. For example, a data governance and security platform can be used for EDEs of the financial institution in order to enable fine-grained controls, usage monitoring, and/or privacy enforcement across big data and analytical workloads. For example, the security controls 604 module can be implemented into the data aggregation platform to provide security controls, logging, and monitoring for critical and extremely sensitive financial data. Financial institutions implement layered controls to protect data confidentiality, integrity, and availability. For security, data aggregation platforms leverage role-based access controls, encryption for data in transit and at rest, VPNs, firewalls, and network segmentation to isolate systems.

The enterprise pipeline (EPL) 606 is a component enabling real-time data aggregation in financial institutions. For example, the enterprise pipeline 606 can be a CCS data pipeline using CIF and/or DCI for data transfer operations. The enterprise pipeline 606 provides a scalable, high-throughput messaging backbone to connect disparate systems and move large volumes of financial data into the central aggregation platform. The EPL leverages a distributed publish-subscribe architecture pattern to provide fault-tolerant messaging system running on a cluster of servers (e.g., Apache Kafka). The aggregation platform consumes these streams, applies data quality checks, transforms the data, and loads into the aggregated data store. With the EPL financial institutions gain a scalable, high-speed messaging backbone to funnel terabytes of data from siloed systems into the aggregated data platform. This enables unified analytics, compliance reporting, and decision making based on timely, comprehensive data.

FIG. 7 illustrates a block diagram 700 including a capabilities view of the right side of the system 356 architecture that is continued from FIG. 6, in accordance with one embodiment. FIG. 7 is similar in many respects to FIG. 5, sharing certain similar features and components. For brevity, only specific elements are detailed and described with reference to FIG. 5.

Data from aggregators, other sources, off-lake applications, and EDE SOR/SOO layers is consumed and ingested at points A, B, and/or C into a production (batch) cluster 706 of the data lake platform (production) 704. The production (or batch) cluster 706 in an enterprise data environment (EDE) for a financial institution can be one or more dedicated compute infrastructures optimized for running large-scale, business-critical batch processing workloads. These clusters, including the production (batch) cluster 706 on the data lake platform (production) 704, as well as the production or batch cluster 716 on the data lake platform (BCP) 712, comprise many high-performance servers, storage, and network resources aggregated to provide massive parallel processing capabilities. The production cluster(s) are designed to efficiently execute recurrent bulk processing jobs that transform large volumes of data.

For example, in financial services, production clusters run end-of-day batch jobs for activities like loan processing, risk modeling, regulatory reporting, trade settlement, and ledger updates. These long-running jobs have high compute and data requirements but can be made highly parallelizable. Production clusters allow scheduling, orchestrating, monitoring, and managing the execution of such jobs at scale. They provide resilience for mission-critical workflows with failover capabilities. Optimized hardware, grid processing frameworks, and workload managers allow maximizing throughput. Segregating batch workloads from transactional systems also improves performance isolation. Production clusters allow financial institutions to run business-critical batch processing reliably and at massive scale to support functions like risk management, regulatory compliance, and transaction processing. Their high-performance parallel processing capabilities are tailored for the unique needs of batch workloads in financial services.

The BI cluster 708 in an enterprise data environment for a financial institution refers to a dedicated analytics infrastructure designed to support business intelligence workloads and data science applications. The BI cluster 708 comprises a pool of resources including servers, storage, networking, software, and tools optimized to provide high performance analysis, reporting, and predictive modeling capabilities. The BI cluster segregates analytics processing from transactional systems to prevent resource contention. It allows for scaling compute and memory resources to accelerate complex queries, algorithms, and multidimensional calculations on large datasets required for BI insights. The cluster employs technologies like in-memory databases, columnar storage, cluster computing frameworks, and GPUs to boost performance. By consolidating analytical workflows onto a high-performance BI cluster, financial institutions can deliver interactive dashboards, generate reports, and build models for risk management, fraud detection, marketing optimization and other data-intensive use cases. It enables data scientists, business analysts and other users to efficiently derive insights from massive amounts of structured and unstructured data within the enterprise. The BI cluster 708 allows for orchestration, load balancing, high availability, and management of the infrastructure to support business critical analytics at scale. With its tailored architecture for BI workloads, the BI cluster enhances productivity and time-to-insight for data-driven decision making in financial institutions.

The ad hoc cluster 710 in an enterprise data environment for a financial institution refers to an on-demand analytics infrastructure provisioned to meet temporary processing requirements for business intelligence and data science workloads. It provides a flexible pool of computing resources to handle analytical tasks that go beyond the capacity of the core BI infrastructure. Financial institutions may spin up an ad hoc cluster to support short-term initiatives like a new model development effort, an intensive marketing campaign analysis, or regulatory reporting crunch. For example, the ad hoc cluster 710 allows for dynamically allocating servers, storage, memory, GPUs, and other resources to scale up capacity for the duration of the ad hoc workload. Rather than overprovisioning the main BI cluster, the ad hoc cluster cost-effectively handles usage spikes. It can leverage cloud-based resources to rapidly add capacity. The ad hoc architecture grants resources on demand to data scientists, business analysts and other users to satisfy their transient analytical needs. For example, the CCS team space 546 as described and depicted in connection with FIG. 5 can be located on the ad hoc cluster 710.

Returning to production (batch) cluster 706, any and all such data is mirrored according to data mirroring 702 techniques to be passed into an ad hoc cluster 710 and a business intelligence cluster 708, which further mirrors the data in data lake platform (BCP) 712. Data mirroring is a technique used in enterprise data environments at financial institutions to create redundant copies of critical data for improved reliability, availability, and disaster recovery. It involves real-time replication of data from a primary database server to one or more standby servers that act as exact copies or mirrors. Write operations on the primary database are synchronously duplicated on the mirror databases to maintain consistency.

In order to further provide for data security and redundancy, data is mirrored from the business intelligence cluster 708 to corresponding clusters on the data lake platform (BCP) 712. For example, BCP Oxmoor can be one example of a business continuity planning site that serves as a backup data center for financial institutions to provide operational resilience and disaster recovery capabilities. The data lake platform (BCP) 712 can include an analytics/BI platform (BCP) 714, including, for example Oxmoor, Winston Salem, or the like.

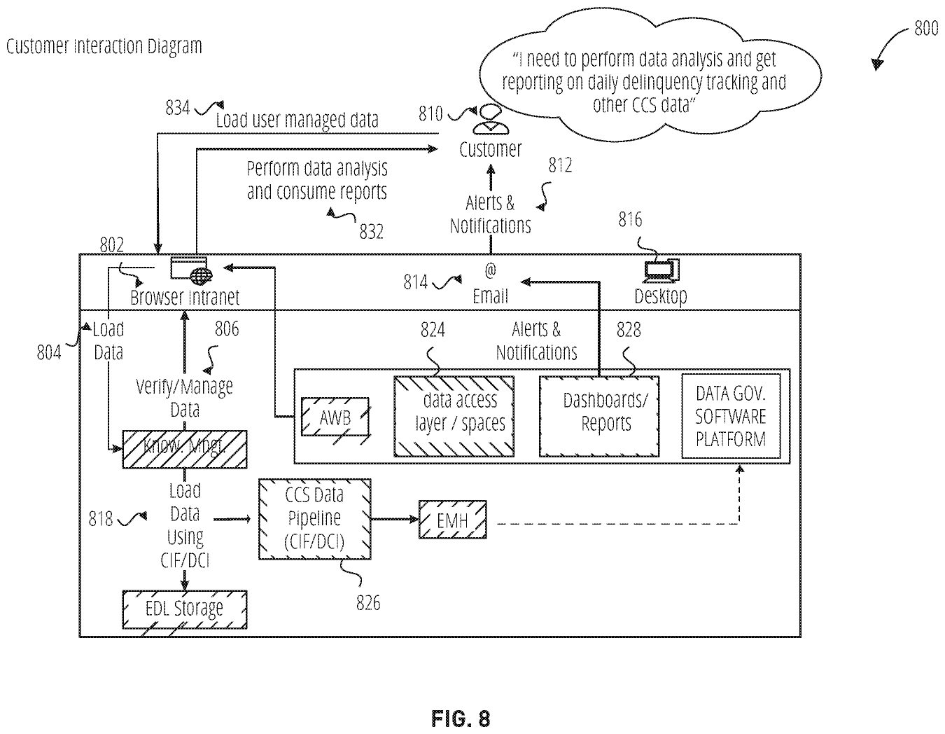

FIG. 8 illustrates an aspect of a customer interaction block diagram 800, in accordance with one embodiment. FIG. 8 is similar in many respects to FIGS. 2 and 3, sharing certain similar features and components. For brevity, only specific elements are detailed and described with reference to FIG. 8.

A customer 810 (e.g., data analyst, non-technical user, etc.) of the consumer collections and servicing analytics platform and application 202 can enter a request, such as: “I need to perform data analysis and get reporting on daily delinquency tracking and other consumer collections and servicing (CCS) data.” Once a search or query request is entered in the platform, the application loads user managed data 834 into a browser intranet 802 for consumption, ingestion, and transformation according to the present disclosure.

The user managed data capability in financial institution desktop environments empowers end users (e.g., customer 810) to directly access, analyze, and share data without IT involvement, and works via self-service data preparation. For example, unskilled users can access and integrate data from diverse sources like spreadsheets, databases, internal systems, and cloud applications via self-service tools. These provide intuitive, visual interfaces to join, shape, cleanse and enrich data for analysis without coding. Users can blend enterprise data with local data and external third-party data. The user desktop environment also includes augmented analytics for leveraging techniques like AI, machine learning, and natural language, augmented analytics automates insight generation from data. For example, users can generate forecasts, trends, correlations, sentiments, categorizations, predictions and more at the click of a button, without the need for programming skills, data analytics backgrounds, or the like (e.g., users do no need data science skills).

The application loads the data 804 into a knowledge management methodology, which is used for multiple steps, including verifying, and managing the data at step 806, which is returned to the customer 810. The management methodology further loads the data using CIF and/or DCI techniques 818 into both an enterprise data lake (EDL) storage, as well as a CCS data pipeline 826.

Following the CCS data pipeline 826, data is managed, transformed, collected, and analyzed as described in detail in connection with FIGS. 2 and 3, and presented in a visual representation via dashboards and reports 828. An alert and/or notification alert or notifications 812 is sent to the customer 810 via, for example, an email 814, to the customer's desktop 816. According to examples of the block diagram 800, the desktop 816, upon which any one or more of the techniques (e.g., methodologies) discussed herein may be performed. The desktop 816 may operate as a standalone device or may be connected (e.g., networked) to other machines. In a networked deployment, the desktop 816 may operate in the capacity of a server machine, a client machine, or both in server-client network environments.

In addition, the dashboard and reports 828 are passed to a data access layer 824, such as an aggregated workbench (AWB) to provide additional data access, preparation, analytics, and collaboration capabilities on top of the aggregated data platforms of the financial institution. The dashboard and reports 828 are further provided to a data lake engine technology used in the reporting and analytics environments to enable direct and rapid querying of large volumes of structured, unstructured, and semi-structured data across the financial institution. The processed data is returned back to the browser or intranet 802 of the customer and the finalized product is returned to the customer to perform data analysis and consume reports 832.

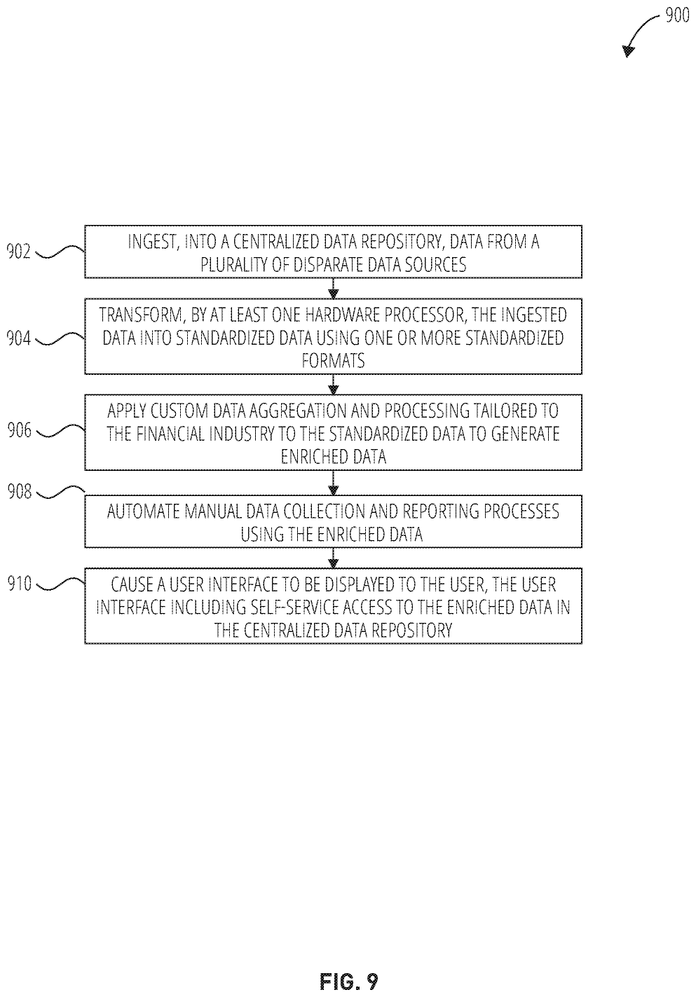

FIG. 9 shows an example flow diagram of a method 900 for enabling data ingestion into a centralized data repository to include data from a plurality of disparate data sources. For example, the method 900 provides for implementing data aggregation on a consumer collections and servicing analytics platform and application, according to some example embodiments.

According to the example embodiments of FIG. 9, different example embodiments disclose methods of the CCS application 342. For example, the method 900 can be embodied in machine-readable instructions for execution by one or more hardware components (e.g., one or more processors) such that the operations of the method 900 can be performed by components of the consumer collections and servicing analytics platform and application 202. Accordingly, the method 900 is described below, by way of example with reference to components of the consumer collections and servicing analytics platform and application 202. However, it shall be appreciated that the method 900 can be deployed on various other hardware configurations and is not intended to be limited to deployment within the platform and/or application. Depending on the embodiment, an operation of the method 900 can be repeated in different ways or involve intervening operations not shown. Though the operations of the method 900 can be depicted and described in a certain order, the order in which the operations are performed may vary among embodiments, including performing certain operations in parallel or performing sets of operations in separate processes. While the various operations in the method 900 are presented and described sequentially, one of ordinary skill will appreciate that some or all of the operations may be executed in a different order, be combined or omitted, or be executed in parallel.

In block 902, method 900 ingests, into a centralized data repository, data from a plurality of disparate data sources. In block 904, method 900 transforms, by at least one hardware processor, the ingested data into standardized data using one or more standardized formats. In block 906, method 900 applies custom data aggregation and processing tailored (e.g., rules, calculations, models, etc.) to the financial industry to the standardized data to generate enriched data. In block 908, method 900 automates manual data collection and reporting processes using the enriched data. In block 910, method 900 causes a user interface to be displayed to the user, the user interface including self-service access to the enriched data in the centralized data repository.

Described implementations of the subject matter can include one or more features, alone or in combination as illustrated below by way of example. Each of these non-limiting examples can stand on its own or can be combined in various permutations or combinations with one or more of the other examples. The following examples detail certain aspects of the present subject matter to solve the challenges and provide the benefits discussed herein.

Example 1 is a system for interfacing a computing system with a user device, the system comprising: at least one processor; and a machine-readable medium comprising instructions thereon that, when executed by the at least one processor, cause the at least one processor to perform operations comprising: ingesting, into a centralized enterprise data lake, data from a plurality of heterogeneous data sources related to a financial institution; transforming the ingested data into standardized data using a standardized format, including standardized data types and standardized data structures; generating enriched data based on applying custom financial data processing on the standardized data; storing the enriched data in the centralized enterprise data lake, the storing including associating the enriched data with related standardized data in a raw form and a curated form; automating manual processes for near real-time analytics of the enriched data using orchestrated pipelines; and causing a user interface to be displayed to the user device, the user interface providing access to self-service data, preparation, and analytics of the enriched data generated by the automated processes stored in the centralized enterprise data lake.

In Example 2, the subject matter of Example 1 includes, wherein the machine-readable medium further includes the instructions thereon that, when executed by the at least one processor, cause the at least one processor to perform the operations comprising: employing one or more data visualization tools to generate output based on the enriched data, the one or more data visualization tools providing data-driven insights to non-technical users.

In Example 3, the subject matter of any of Examples 1-2 includes, wherein the machine-readable medium further includes the instructions thereon that, when executed by the at least one processor, cause the at least one processor to perform the operations comprising: analyzing the enriched data using a distributed processing framework to determine customer journey data, the customer journey data including one or more interactions with one or more communication channels of the financial institution; automatically generating a customer journey mapping, the mapping including associating each interaction with each communication channel of the financial institution; storing the customer journey mapping in the centralized enterprise data lake; and enabling a user to search the centralized enterprise data lake using a natural language query to identify each interaction of the customer journey mapping based on the enriched data.

In Example 4, the subject matter of Example 3 includes, wherein the machine-readable medium further includes the instructions thereon that, when executed by the at least one processor, cause the at least one processor to perform the operations comprising: maximizing customer contact and customer engagement with the financial institution based on data-driven insight aggregated from the enriched data; and identifying an optimal communication characteristic to communicate with a customer based on the customer journey mapping.

In Example 5, the subject matter of Example 4 includes, wherein the optimal communication characteristic for the customer includes a time of day and a communication channel, the communication channel including at least one of a physical location, a website application, a mobile application, an online chatbot, or a telephone number, and wherein the machine-readable medium further includes the instructions thereon that, when executed by the at least one processor, cause the at least one processor to perform the operations comprising: identifying the optimal communication characteristic while adhering to a regulatory requirement associated with the customer contact and the customer engagement with the financial institution.

In Example 6, the subject matter of any of Examples 1-5 includes, wherein the machine-readable medium further includes the instructions thereon that, when executed by the at least one processor, cause the at least one processor to perform the operations comprising: employing machine learning techniques to analyze query intent and extract data from the centralized enterprise data lake to support data preparation and data analytics; and generating output based on the data preparation and the data analytics, the output including at least one of a report, an intuitive dashboard, or an interactive visualization.

In Example 7, the subject matter of any of Examples 1-6 includes, wherein the machine-readable medium further includes the instructions thereon that, when executed by the at least one processor, cause the at least one processor to perform the operations comprising: providing access controls to allow different user roles to access different parts of the enriched data; and providing a simplified user interface tailored to each of the different user roles.

In Example 8, the subject matter of any of Examples 1-7 includes, wherein the automating of the manual processes for the near real-time analytics of the enriched data using the orchestrated pipelines further includes: employing programmatic aggregation of data from multiple systems, wherein the programmatic aggregation includes machine-based gathering of data previously collected manually.

In Example 9, the subject matter of any of Examples 1-8 includes, wherein the machine-readable medium further includes the instructions thereon that, when executed by the at least one processor, cause the at least one processor to perform the operations comprising: collecting the data in real-time, in near-real-time, and in batches from the plurality of heterogeneous data sources related to the financial institution; and consuming the collected data using data collection tools configured to aggregate and ingest data from various sources into the centralized enterprise data lake.

Example 10 is a method for interfacing a computing system with a user device, the method comprising: ingesting, into a centralized enterprise data lake, data from a plurality of heterogeneous data sources related to a financial institution; transforming the ingested data into standardized data using a standardized format, including standardized data types and standardized data structures; generating enriched data based on applying custom financial data processing on the standardized data; storing the enriched data in the centralized enterprise data lake, the storing including associating the enriched data with related standardized data in a raw form and a curated form; automating manual processes for near real-time analytics of the enriched data using orchestrated pipelines; and causing a user interface to be displayed to the user device, the user interface providing access to self-service data, preparation, and analytics of the enriched data generated by the automated processes stored in the centralized enterprise data lake.

In Example 11, the subject matter of Example 10 includes, employing one or more data visualization tools to generate output based on the enriched data, the one or more data visualization tools providing data-driven insights to non-technical users.

In Example 12, the subject matter of any of Examples 10-11 includes, analyzing the enriched data using a distributed processing framework to determine customer journey data, the customer journey data including one or more interactions with one or more communication channels of the financial institution; automatically generating a customer journey mapping, the mapping including associating each interaction with each communication channel of the financial institution; storing the customer journey mapping in the centralized enterprise data lake; and enabling a user to search the centralized enterprise data lake using a natural language query to identify each interaction of the customer journey mapping based on the enriched data.

In Example 13, the subject matter of Example 12 includes, maximizing customer contact and customer engagement with the financial institution based on data-driven insight aggregated from the enriched data; and identifying an optimal communication characteristic to communicate with a customer based on the customer journey mapping.

In Example 14, the subject matter of Example 13 includes, wherein the optimal communication characteristic for the customer includes a time of day and a communication channel, the communication channel including at least one of a physical location, a website application, a mobile application, an online chatbot, or a telephone number, and further comprising: identifying the optimal communication characteristic while adhering to a regulatory requirement associated with the customer contact and the customer engagement with the financial institution.

In Example 15, the subject matter of any of Examples 11-14 includes, employing machine learning techniques to analyze query intent and extract data from the centralized enterprise data lake to support data preparation and data analytics; and generating output based on the data preparation and the data analytics, the output including at least one of a report, an intuitive dashboard, or an interactive visualization.

In Example 16, the subject matter of any of Examples 11-15 includes, wherein the standardized formats comprise standardized data types and standardized data structures, and further comprising: providing access controls to allow different user roles to access different parts of the enriched data; providing a simplified user interface tailored to each of the different user roles; and employing programmatic aggregation of data from multiple systems, wherein the programmatic aggregation includes machine-based gathering of data previously collected manually.

Example 17 is a non-transitory machine-readable medium having instructions thereon that, when executed by at least one processor, cause the at least one processor to perform operations comprising: ingesting, into a centralized enterprise data lake, data from a plurality of heterogeneous data sources related to a financial institution; transforming the ingested data into standardized data using a standardized format, including standardized data types and standardized data structures; generating enriched data based on applying custom financial data processing on the standardized data; storing the enriched data in the centralized enterprise data lake, the storing including associating the enriched data with related standardized data in a raw form and a curated form; automating manual processes for near real-time analytics of the enriched data using orchestrated pipelines; and causing a user interface to be displayed to a user device, the user interface providing access to self-service data, preparation, and analytics of the enriched data generated by the automated processes stored in the centralized enterprise data lake.

In Example 18, the subject matter of Example 17 includes, wherein the non-transitory machine-readable medium further includes the instructions that, when executed by the at least one processor, cause the at least one processor to perform the operations comprising: analyzing the enriched data using a distributed processing framework to determine customer journey data, the customer journey data including one or more interactions with one or more communication channels of the financial institution; automatically generating a customer journey mapping, the mapping including associating each interaction with each communication channel of the financial institution; storing the customer journey mapping in the centralized enterprise data lake; and enabling a user to search the centralized enterprise data lake using a natural language query to identify each interaction of the customer journey mapping based on the enriched data.

In Example 19, the subject matter of Example 18 includes, wherein the non-transitory machine-readable medium further includes the instructions that, when executed by the at least one processor, cause the at least one processor to perform the operations comprising: maximizing customer contact and customer engagement with the financial institution based on data-driven insight aggregated from the enriched data; identifying an optimal communication characteristic to communicate with a customer based on the customer journey mapping, wherein the optimal communication characteristic for the customer includes a time of day and a communication channel, the communication channel including at least one of a physical location, a website application, a mobile application, an online chatbot, or a telephone number; and identifying the optimal communication characteristic while adhering to a regulatory requirement associated with the customer contact and the customer engagement with the financial institution.

In Example 20, the subject matter of any of Examples 17-19 includes, wherein the non-transitory machine-readable medium further includes the instructions that, when executed by the at least one processor, cause the at least one processor to perform the operations comprising, and wherein the automating of manual data collection and reporting processes using the enriched data further comprises: employing machine learning techniques to analyze query intent and extract data from the centralized enterprise data lake to support data preparation and data analytics; generating output based on the data preparation and the data analytics, the output including at least one of a report, an intuitive dashboard, or an interactive visualization; providing access controls to allow different user roles to access different parts of the enriched data; and providing a simplified user interface tailored to each of the different user roles.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

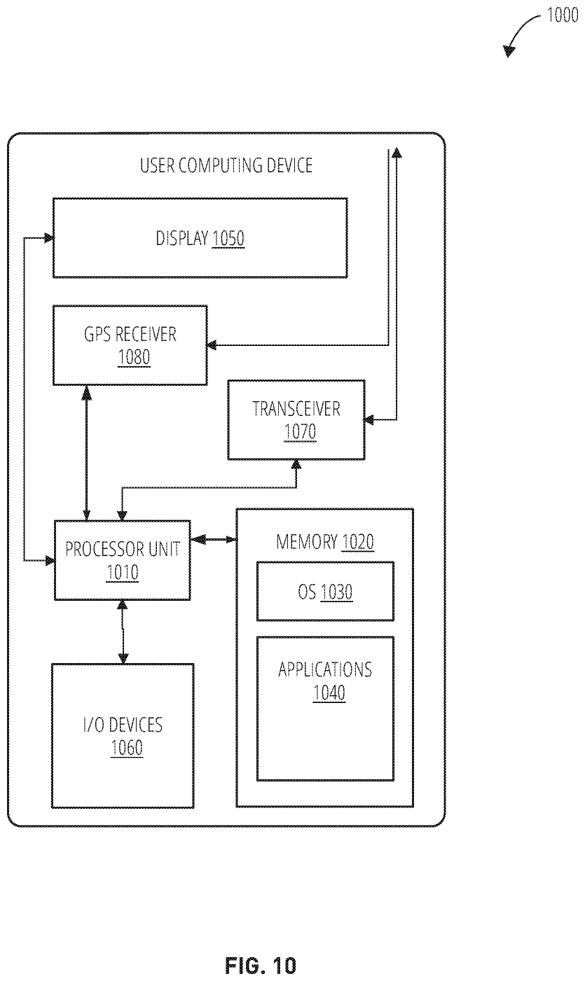

FIG. 10 is a block diagram 1000 showing an example architecture of a user computing device according to some example embodiments. The block diagram 1000 may, for example, describe any of the computing devices described herein, including, for example, the consumer collections and servicing analytics platform and application 202, the desktop 816, a financial services system (not shown), or components thereof.

The block diagram 1000 comprises a processor unit 1010. The processor unit 1010 may include one or more processors. Any of a variety of different types of commercially available processors suitable for computing devices may be used (e.g., an XScale architecture microprocessor, a Microprocessor without Interlocked Pipeline Stages (MIPS) architecture processor, or another type of processor). A memory 1020, such as a Random Access Memory (RAM), a flash memory, or another type of memory or data storage, is typically accessible to the processor unit 1010. The memory 1020 may be adapted to store an operating system (OS) 1030, as well as applications 1040 (e.g., programs).

The processor unit 1010 may be coupled, either directly or via appropriate intermediary hardware, to a display 1050 and to one or more input/output (I/O) devices 1060, such as a keypad, a touch panel sensor, a microphone, and the like. Such I/O devices 1060 may include a touch sensor for capturing fingerprint data, a camera for capturing one or more images of the user, a retina scanner, or any other suitable devices. The I/O devices 1060 may be used to implement I/O channels, as described herein. In some examples, the I/O devices 1060 may also include sensors.

Similarly, in some examples, the processor unit 1010 may be coupled to a transceiver 1070 that interfaces with an antenna (not shown). The transceiver 1070 may be configured to both transmit and receive cellular network signals, wireless data signals, or other types of signals via the antenna (not shown), depending on the nature of the computing device implemented by the architecture. Although one transceiver 1070 is shown, in some examples, the architecture includes additional transceivers. For example, a wireless transceiver may be utilized to communicate according to an IEEE 1202.11 specification, such as Wi-Fi and/or a short-range communication medium. Some short-range communication mediums, such as NFC, may utilize a separate, dedicated transceiver. Further, in some configurations, a Global Positioning System (GPS) receiver 1080 may also make use of the antenna to receive GPS signals. In addition to or instead of the GPS receiver 1080, any suitable location-determining sensor may be included and/or used, including, for example, a Wi-Fi positioning system. In some examples, the architecture (e.g., the processor unit 1010) may also support a hardware interrupt. In response to a hardware interrupt, the processor unit 1010 may pause its processing and execute an interrupt service routine (ISR).

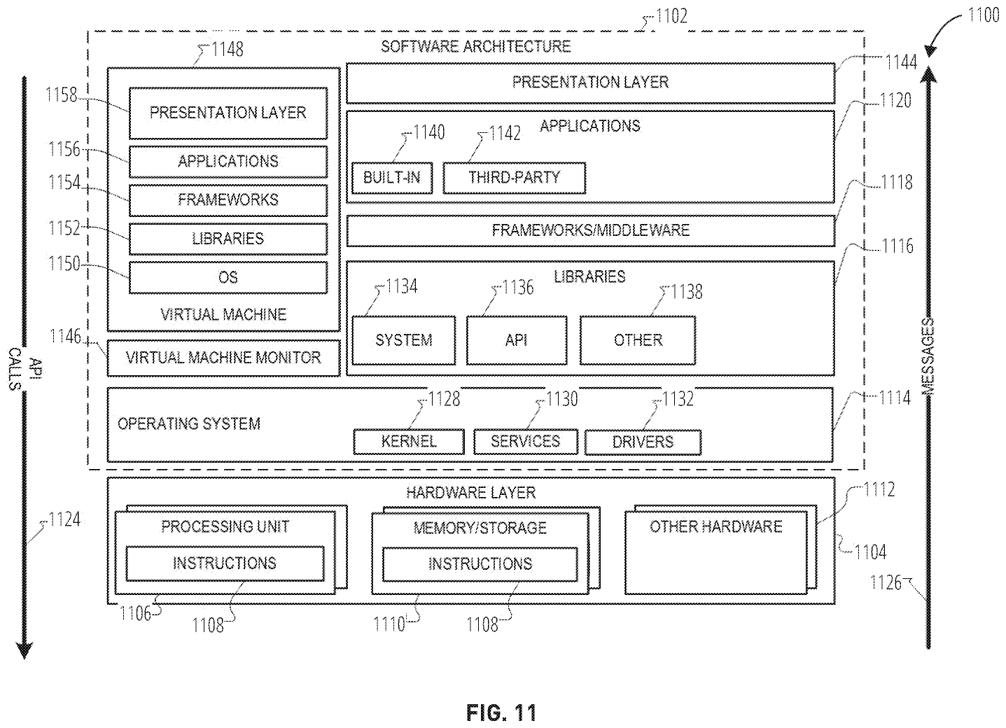

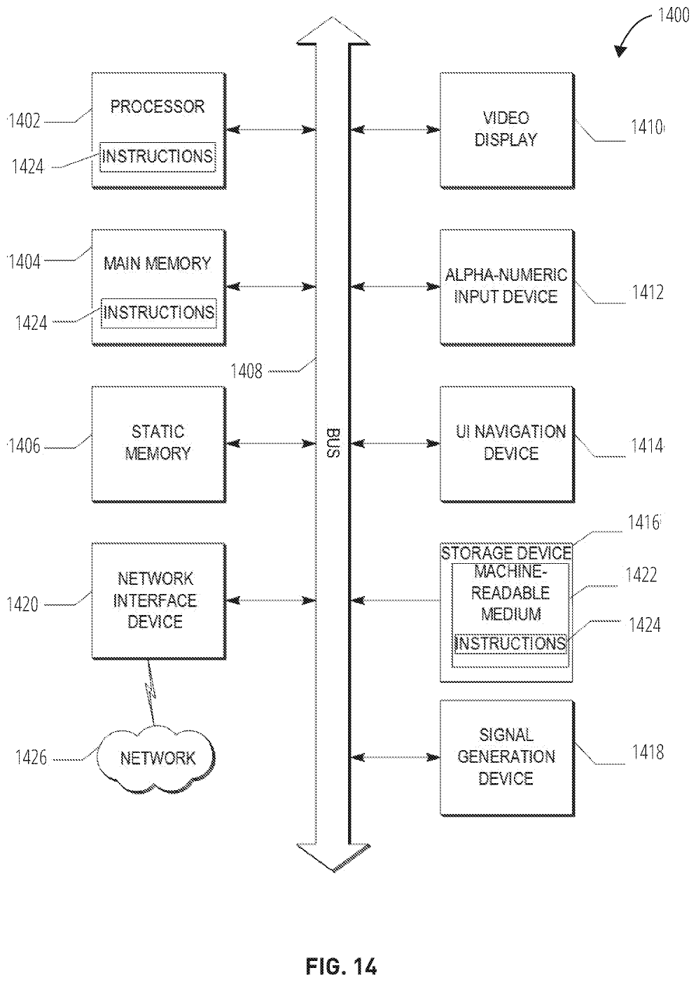

FIG. 11 is a block diagram 1100 showing one example of a processor 1402 for a computing device. The software architecture 1102 may be used in conjunction with various hardware architectures, for example, as described herein. FIG. 11 is merely a non-limiting example of a software architecture 1102, and many other architectures may be implemented to facilitate the functionality described herein. A representative hardware layer 1104 is illustrated and can represent, for example, any of the above-referenced computing devices. In some examples, the hardware layer 1104 may be implemented according to an architecture 1300 of FIG. 14 and/or the block diagram 1000 of FIG. 10.

The representative hardware layer 1104 comprises one or more processing units 1106 having associated executable instructions 1108. The executable instructions 1108 represent the executable instructions of the software architecture 1102, including implementation of the methods, modules, components, and so forth of FIGS. 2-9. The hardware layer 1104 also includes memory and/or storage modules 1110, which also have the executable instructions 1108. The hardware layer 1104 may also comprise other hardware 1112, which represents any other hardware of the hardware layer 1104, such as the other hardware illustrated as part of the architecture 1300.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120, and a presentation layer 1144. Operationally, the applications 1120 and/or other components within the layers may invoke application programming interface (API) 1124 through the software stack and receive a response, returned values, and so forth illustrated as messages 1126 in response to the API calls 1124. The layers illustrated are representative in nature and not all software architectures have all layers. For example, some mobile or special-purpose operating systems may not provide a frameworks/middleware 1118 layer, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of a hardware or software interrupt and, in response, cause the software architecture 1102 to pause its current processing and execute an ISR when an interrupt is received. The ISR may generate an alert.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than by interfacing directly with the underlying operating system 1114 functionality (e.g., kernel 1128, services 1130, and/or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks 1118 (also sometimes referred to as middleware) may provide a higher-level common infrastructure that may be utilized by the applications 1120 and/or other software components/modules. For example, the frameworks 1118 may provide various graphical user interface (GUI) functions, high-level resource management, high-level location services, and so forth. The frameworks 1118 may provide a broad spectrum of other APIs that may be utilized by the applications 1120 and/or other software components/modules, some of which may be specific to a particular operating system or platform.

The applications 1120 include built-in applications 1140 and/or third-party applications 1142. Examples of representative built-in applications 1140 may include, but are not limited to, a contacts application, a browser application, a book reader application, a location application, a media application, a messaging application, and/or a game application. The third-party applications 1142 may include any of the built-in applications 1140 as well as a broad assortment of other applications. In a specific example, the third-party application 1142 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 1142 may invoke the API calls 1124 provided by the mobile operating system such as the operating system 1114 to facilitate functionality described herein.

The applications 1120 may utilize built-in operating system functions (e.g., kernel 1128, services 1130, and/or drivers 1132), libraries (e.g., system libraries 1134, API libraries 1136, and other libraries 1138), or frameworks/middleware 1118 to create user interfaces to interact with users of the system. Alternatively, or additionally, in some systems, interactions with a user may occur through a presentation layer, such as the presentation layer 1144. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 11, this is illustrated by a virtual machine 1148. A virtual machine creates a software environment where applications/modules can execute as if they were executing on a hardware computing device. The virtual machine 1148 is hosted by a host operating system (e.g., the operating system 1114) and typically, although not always, has a virtual machine monitor 1146, which manages the operation of the virtual machine 1148 as well as the interface with the host operating system (e.g., the operating system 1114). A software architecture executes within the virtual machine 1148, such as an operating system 1150, libraries 1152, frameworks/middleware 1154, applications 1156, and/or a presentation layer 1158 within the VM 1148. These layers of software architecture executing within the virtual machine 1148 can be the same as corresponding layers previously described or may be different.

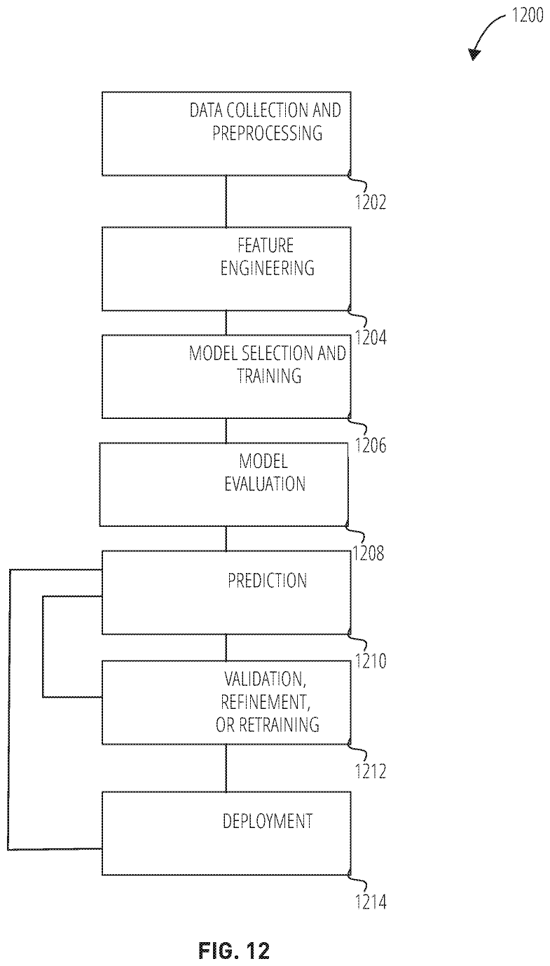

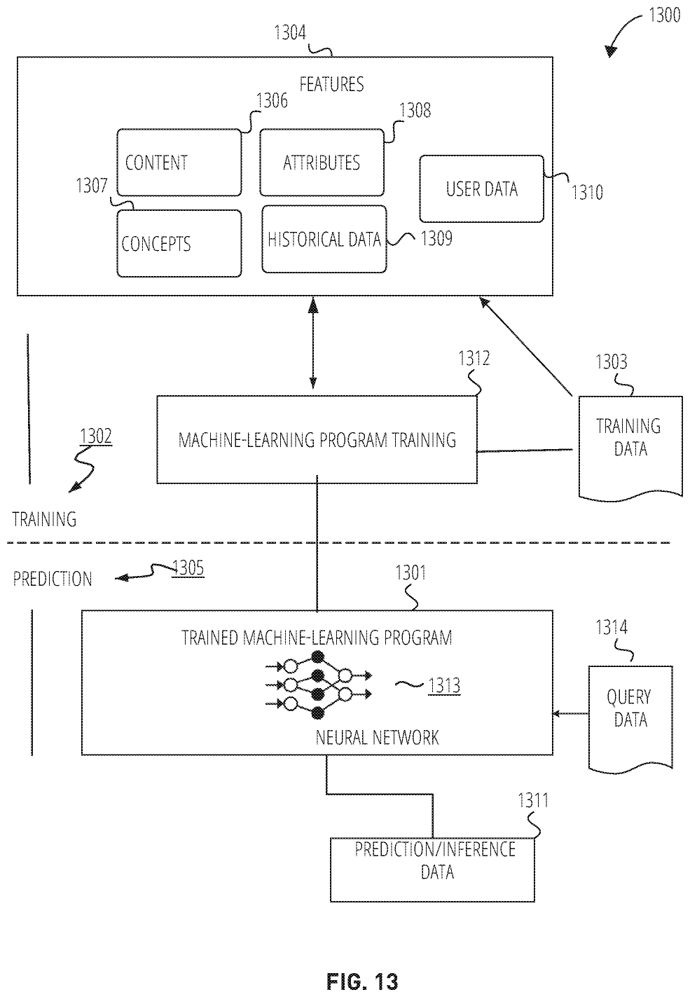

FIG. 12 depicts a machine-learning pipeline 1200 and FIG. 13 illustrates training and use of a machine-learning program (e.g., model) 1300. Specifically, FIG. 12 is a flowchart depicting a machine-learning pipeline 1200, according to some examples. The block diagram 1200 can be used to generate a trained model, for example the trained machine-learning program 1302 of FIG. 13, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, self-supervised, and reinforcement learning.

For example, supervised learning involves training a model using labeled data to predict an output for new, unseen inputs. Examples of supervised learning algorithms include linear regression, decision trees, and neural networks. Unsupervised learning involves training a model on unlabeled data to find hidden patterns and relationships in the data. Examples of unsupervised learning algorithms include clustering, principal component analysis, and generative models like autoencoders. Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phases 1302 as described and depicted in connection with FIG. 13, generating a trained machine-learning program 1301 may include multiple phases that form part of the machine-learning pipeline as illustrated in the block diagram 1200, including for example the following phases illustrated in FIG. 12: data collection and preprocessing 1202, feature engineering 1204, model selection and training 1206, model evaluation 1208, prediction 1210, validation, refinement, or retraining 1212, and deployment 1214, or a combination thereof.

For example, data collection and preprocessing 1202 can include a phase for acquiring and cleaning data to ensure that it is suitable for use in the machine learning model. This phase may also include removing duplicates, handling missing values, and converting data into a suitable format. Feature engineering 1204 can include a phase for selecting and transforming the training data 1206 to create features that are useful for predicting the target variable. Feature engineering may include (1) receiving features 1208 (e.g., as structured or labeled data in supervised learning) and/or (2) identifying features 1208 (e.g., unstructured, or unlabeled data for unsupervised learning) in training data 1206. Model selection and training 1206 can include a phase for selecting an appropriate machine learning algorithm and training it on the preprocessed data. This phase may further involve splitting the data into training and testing sets, using cross-validation to evaluate the model, and tuning hyperparameters to improve performance.

In additional examples, model evaluation 1208 can include a phase for evaluating the performance of a trained model (e.g., the trained machine-learning program 1301) on a separate testing dataset. This phase can help determine if the model is overfitting or underfitting and determine whether the model is suitable for deployment. Prediction 1210 can include a phase for using a trained model (e.g., trained machine-learning program 1302) to generate predictions on new, unseen data. Validation, refinement or retraining 1312 can include a phase for updating a model based on feedback generated from the prediction phase, such as new data or user feedback. Deployment 1214 can include a phase for integrating the trained model (e.g., the trained machine-learning program 1302) into a more extensive system or application, such as a web service, mobile app, or IoT device. This phase can involve setting up APIs, building a user interface, and ensuring that the model is scalable and can handle large volumes of data.

FIG. 13 illustrates further details of two example phases, namely a training phase 1302 (e.g., part of the model selection and training 1206) and a prediction phase 1305 (part of prediction 1210). Prior to the training phase 1302, feature engineering 1304 is used to identify features 1308. This may include identifying informative, discriminating, and independent features for effectively operating the trained machine-learning program 1302 in pattern recognition, classification, and regression.

In some examples, the training data 1306 includes labeled data, known for pre-identified features 1308 and one or more outcomes. Each of the features 1304 may be a variable or attribute, such as an individual measurable property of a process, article, system, or phenomenon represented by a data set (e.g., the training data, content 1306). Features 1308 may also be of different types, such as numeric features, strings, and graphs, and may include one or more of content 1306, concepts 1307, attributes 1308, historical data 1309, and/or user data 1310, merely for example. In training phase 1302, the machine-learning pipeline 1300 uses the training data 1303 to find correlations among the features 1304 that affect a predicted outcome or prediction/inference data 1311.

With the training data 1303 and the identified features 1304, the trained machine-learning program 1301 is trained during the training phase 1302 during machine-learning program training 1312. The machine-learning program training 1324 appraises values of the features 1304 as they correlate to the training data 1303. The result of the training is the trained machine-learning program 1301 (e.g., a trained or learned model).

Further, the training phase 1302 may involve machine learning, in which the training data 1303 is structured (e.g., labeled during preprocessing operations). The trained machine-learning program 1301 implements a neural network 1313 capable of performing, for example, classification and clustering operations. In other examples, the training phase 1302 may involve deep learning, in which the training data 1303 is unstructured, and the trained machine-learning program 1302 implements a deep neural network that can perform both feature extraction and classification/clustering operations.

In some examples, a neural network 1313 may be generated during the training phase 1302 and implemented within the trained machine-learning program 1301. The neural network 1313 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 1313 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1313 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1302, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 1305, the trained machine-learning program 1301 uses the features 1304 for analyzing query data 1314 to generate inferences, outcomes, or predictions, as examples of a prediction/inference data 1311. For example, during prediction phase 1305, the trained machine-learning program 1301 generates an output. Query data 1314 is provided as an input to the trained machine-learning program 1312, and the trained machine-learning program 1302 generates the prediction/inference data 1311 as output, responsive to receipt of the query data 1314.

In some examples, the trained machine-learning program 1301 may be a generative AI model. Generative AI is a term that may refer to any type of artificial intelligence that can create new content from training data 1306. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variationally autoencoders, transformer models, and the like.

For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variationally autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 1311 can include predictions, translations, summaries, media content, and the like, or some combination thereof.

In some example embodiments, computer-readable files come in several varieties, including unstructured files, semi-structured files, and structured files. These terms may mean different things to different people. Examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data.

As used herein, examples of unstructured files include image files, video files, PDFs, audio files, and the like; examples of semi-structured files include JavaScript Object Notation (JSON) files, extensible Markup Language (XML) files, and the like. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a cloud data platform can include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A cloud data platform may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a data lake platform 340, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object such as a database may itself contain one or more objects such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

In the present disclosure, physical units of data that are stored in a cloud data platform—and that make up the content of, e.g., database tables in customer accounts (e.g., customer users)—are referred to as micro-partitions. In different implementations, a cloud data platform can store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the cloud data platform, a given file is referred to herein as an “internal file” and may be stored in (or at, or on, etc.) what is referred to herein as an “internal storage location.” If stored external to the cloud data platform, a given file is referred to herein as an “external file” and is referred to as being stored in (or at, or on, etc.) what is referred to herein as an “external storage location.”

While example embodiments of the present disclosure reference commands in the standardized syntax of the programming language Structured Query Language (SQL), it will be understood by one having ordinary skill in the art that the present disclosure can similarly apply to other programming languages associated with communicating and retrieving data from a database.

FIG. 14 is a block diagram illustrating a computing device hardware architecture 1400, within which a set or sequence of instructions can be executed to cause a machine to perform examples of any one of the methodologies discussed herein. The architecture 1400 may describe, for example, any of the computing devices and/or control circuits described herein.

The architecture 1400 may execute the software architecture 1102 described with respect to FIG. 11. The architecture 1400 may operate as a standalone device or may be connected (e.g., networked) to other machines. In a networked deployment, the architecture 1400 may operate in the capacity of either a server or a client machine in server-client network environments, or it may act as a peer machine in peer-to-peer (or distributed) network environments. The architecture 1400 can be implemented in a personal computer (PC), a tablet PC, a hybrid tablet, a set-top box (STB), a personal digital assistant (PDA), a mobile telephone, a web appliance, a network router, a network switch, a network bridge, or any machine capable of executing instructions (sequential or otherwise) that specify operations to be taken by that machine.

The example architecture 1400 includes a processor unit 1402 comprising at least one processor (e.g., a central processing unit (CPU), a graphics processing unit (GPU), or both, processor cores, compute nodes, etc.). The architecture 1400 may further comprise a main memory 1404 and a static memory 1406, which communicate with each other via a link 1408 (e.g., a bus). The architecture 1400 can further include a video display unit 1410, an alphanumeric input device 1412 (e.g., a keyboard), and a UI navigation device 1414 (e.g., a mouse). In some examples, the video display unit 1410, alphanumeric input device 1412, and UI navigation device 1414 are incorporated into a touchscreen display. The architecture 1400 may additionally include a storage device 1416 (e.g., a drive unit), a signal generation device 1418 (e.g., a speaker), a network interface device 1420, and one or more sensors (not shown), such as a GPS sensor, compass, accelerometer, or other sensor.

In some examples, the processor unit 1402 or another suitable hardware component may support a hardware interrupt. In response to a hardware interrupt, the processor unit 1402 may pause its processing and execute an ISR, for example, as described herein.

The storage device 1416 includes a machine-readable medium 1422 on which is stored one or more sets of data structures and instructions 1424 (e.g., software) embodying or utilized by any one or more of the methodologies or functions described herein. The instructions 1424 can also reside, completely or at least partially, within the main memory 1404, within the static memory 1406, and/or within the processor unit 1402 during execution thereof by the architecture 1400, with the main memory 1404, the static memory 1406, and the processor unit 1402 also constituting machine-readable media. The instructions 1424 stored at the machine-readable medium 1422 may include, for example, instructions for implementing the software architecture 02, instructions for executing any of the features described herein, etc.

While the machine-readable medium 1422 is illustrated in an example to be a single medium, the term “machine-readable medium” can include a single medium or multiple media (e.g., a centralized or distributed database, and/or associated caches and servers) that store the one or more instructions 1424. The term “machine-readable medium” shall also be taken to include any tangible medium that is capable of storing, encoding, or carrying instructions for execution by the machine and that cause the machine to perform any one or more of the methodologies of the present disclosure, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM) and electrically erasable programmable read-only memory (EEPROM)) and flash memory devices; magnetic disks such as internal hard disks and removable disks; magneto-optical disks; and CD-ROM and DVD-ROM disks.

The instructions 1424 can further be transmitted or received over a communications network 1426 using a transmission medium via the network interface device 1420 utilizing any one of a number of well-known transfer protocols (e.g., hypertext transfer protocol (HTTP)). Examples of communication networks include a LAN, a WAN, the Internet, mobile telephone networks, plain old telephone service (POTS) networks, and wireless data networks (e.g., Wi-Fi, 3G, and 5G LTE/LTE-A or WiMAX networks). The term “transmission medium” shall be taken to include any intangible medium that is capable of storing, encoding, or carrying instructions for execution by the machine, and includes digital or analog communications signals or other intangible media to facilitate communication of such software.

The machine in architecture 1400 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

As used herein, the terms “machine-storage medium,” “device-storage medium,” and “computer-storage medium” mean the same thing and can be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

The terms “machine-readable medium,” “computer-readable medium,” and “device-readable medium” mean the same thing and can be used interchangeably in this disclosure. The terms are defined to include both machine-storage media and transmission media. Thus, the terms include both storage devices/media and carrier waves/modulated data signals.

The various operations of example methods described herein can be performed, at least partially, by one or more processors that are temporarily configured (e.g., by software) or permanently configured to perform the relevant operations. Similarly, the methods described herein can be at least partially processor implemented. For example, at least some of the operations of the methods described herein can be performed by one or more processors. The performance of certain of the operations can be distributed among the one or more processors, not only residing within a single machine, but also deployed across a number of machines. In some example embodiments, the processor or processors can be located in a single location (e.g., within a home environment, an office environment, or a server farm), while in other embodiments the processors can be distributed across a number of locations.

Although the embodiments of the present disclosure have been described with reference to specific example embodiments, it will be evident that various modifications and changes can be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter can be practiced. The embodiments illustrated are described in sufficient detail to enable those skilled in the art to practice the teachings disclosed herein. Other embodiments can be used and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art, upon reviewing the above description.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in an aspect are still deemed to fall within the scope of that aspect. Moreover, in the following aspects, the terms “first,” “second,” and “third,” etc. are used merely as labels, and are not intended to impose numerical requirements on their objects.

Method examples described herein may be machine or computer-implemented at least in part. Some examples may include a computer-readable medium, non-transitory computer-readable medium, or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

Also, in the above Detailed Description, various features can be grouped together to streamline the disclosure. However, the claims cannot set forth every feature disclosed herein, as embodiments can feature a subset of said features. Further, embodiments can include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

What is claimed is:

1. A system for interfacing a computing system with a user device, the system comprising:
at least one processor; and
a machine-readable medium comprising instructions thereon that, when executed by the at least one processor, cause the at least one processor to perform operations comprising:
ingesting, into a centralized enterprise data lake, data from a plurality of heterogeneous data sources related to a financial institution;
transforming the ingested data into standardized data using a standardized format, including standardized data types and standardized data structures;
generating enriched data based on applying custom financial data processing on the standardized data;
storing the enriched data in the centralized enterprise data lake, the storing including associating the enriched data with related standardized data in a raw form and a curated form;
automating manual processes for near real-time analytics of the enriched data using orchestrated pipelines; and
causing a user interface to be displayed to the user device, the user interface providing access to self-service data, preparation, and analytics of the enriched data generated by the automated processes stored in the centralized enterprise data lake.

2. The system of claim 1, wherein the machine-readable medium further includes the instructions thereon that, when executed by the at least one processor, cause the at least one processor to perform the operations comprising:
employing one or more data visualization tools to generate output based on the enriched data, the one or more data visualization tools providing data-driven insights to non-technical users.

3. The system of claim 1, wherein the machine-readable medium further includes the instructions thereon that, when executed by the at least one processor, cause the at least one processor to perform the operations comprising:
analyzing the enriched data using a distributed processing framework to determine customer journey data, the customer journey data including one or more interactions with one or more communication channels of the financial institution;
automatically generating a customer journey mapping, the mapping including associating each interaction with each communication channel of the financial institution;
storing the customer journey mapping in the centralized enterprise data lake; and
enabling a user to search the centralized enterprise data lake using a natural language query to identify each interaction of the customer journey mapping based on the enriched data.

4. The system of claim 3, wherein the machine-readable medium further includes the instructions thereon that, when executed by the at least one processor, cause the at least one processor to perform the operations comprising:
maximizing customer contact and customer engagement with the financial institution based on data-driven insight aggregated from the enriched data; and
identifying an optimal communication characteristic to communicate with a customer based on the customer journey mapping.

5. The system of claim 4, wherein the optimal communication characteristic for the customer includes a time of day and a communication channel, the communication channel including at least one of a physical location, a website application, a mobile application, an online chatbot, or a telephone number, and wherein the machine-readable medium further includes the instructions thereon that, when executed by the at least one processor, cause the at least one processor to perform the operations comprising:
identifying the optimal communication characteristic while adhering to a regulatory requirement associated with the customer contact and the customer engagement with the financial institution.

6. The system of claim 1, wherein the machine-readable medium further includes the instructions thereon that, when executed by the at least one processor, cause the at least one processor to perform the operations comprising:
employing machine learning techniques to analyze query intent and extract data from the centralized enterprise data lake to support data preparation and data analytics; and
generating output based on the data preparation and the data analytics, the output including at least one of a report, an intuitive dashboard, or an interactive visualization.

7. The system of claim 1, wherein the machine-readable medium further includes the instructions thereon that, when executed by the at least one processor, cause the at least one processor to perform the operations comprising:
providing access controls to allow different user roles to access different parts of the enriched data; and
providing a simplified user interface tailored to each of the different user roles.

8. The system of claim 1, wherein the automating of the manual processes for near real-time analytics of the enriched data using the orchestrated pipelines further includes:
employing programmatic aggregation of data from multiple systems, wherein the programmatic aggregation includes machine-based gathering of data previously collected manually.

9. The system of claim 1, wherein the machine-readable medium further includes the instructions thereon that, when executed by the at least one processor, cause the at least one processor to perform the operations comprising:
collecting the data in real-time, in near-real-time, and in batches from the plurality of heterogeneous data sources related to the financial institution; and
consuming the collected data using data collection tools configured to aggregate and ingest data from various sources into the centralized enterprise data lake.

10. A method for interfacing a computing system with a user device, the method comprising:
ingesting, into a centralized enterprise data lake, data from a plurality of heterogeneous data sources related to a financial institution;
transforming the ingested data into standardized data using a standardized format, including standardized data types and standardized data structures;
generating enriched data based on applying custom financial data processing on the standardized data;
storing the enriched data in the centralized enterprise data lake, the storing including associating the enriched data with related standardized data in a raw form and a curated form;
automating manual processes for near real-time analytics of the enriched data using orchestrated pipelines; and
causing a user interface to be displayed to the user device, the user interface providing access to self-service data, preparation, and analytics of the enriched data generated by the automated processes stored in the centralized enterprise data lake.

11. The method of claim 10, comprising:
employing one or more data visualization tools to generate output based on the enriched data, the one or more data visualization tools providing data-driven insights to non-technical users.

12. The method of claim 10, comprising:
analyzing the enriched data using a distributed processing framework to determine customer journey data, the customer journey data including one or more interactions with one or more communication channels of the financial institution;
automatically generating a customer journey mapping, the mapping including associating each interaction with each communication channel of the financial institution;
storing the customer journey mapping in the centralized enterprise data lake; and
enabling a user to search the centralized enterprise data lake using a natural language query to identify each interaction of the customer journey mapping based on the enriched data.

13. The method of claim 12, comprising:
maximizing customer contact and customer engagement with the financial institution based on data-driven insight aggregated from the enriched data; and
identifying an optimal communication characteristic to communicate with a customer based on the customer journey mapping.

14. The method of claim 13, wherein the optimal communication characteristic for the customer includes a time of day and a communication channel, the communication channel including at least one of a physical location, a website application, a mobile application, an online chatbot, or a telephone number, and further comprising:
identifying the optimal communication characteristic while adhering to a regulatory requirement associated with the customer contact and the customer engagement with the financial institution.

15. The method of claim 11, employing machine learning techniques to analyze query intent and extract data from the centralized enterprise data lake to support data preparation and data analytics; and
generating output based on the data preparation and the data analytics, the output including at least one of a report, an intuitive dashboard, or an interactive visualization.

16. The method of claim 11, wherein the standardized formats comprise standardized data types and standardized data structures, and further comprising:
providing access controls to allow different user roles to access different parts of the enriched data;
providing a simplified user interface tailored to each of the different user roles; and
employing programmatic aggregation of data from multiple systems, wherein the programmatic aggregation includes machine-based gathering of data previously collected manually.

17. A non-transitory machine-readable medium having instructions thereon that, when executed by at least one processor, cause the at least one processor to perform operations comprising:
ingesting, into a centralized enterprise data lake, data from a plurality of heterogeneous data sources related to a financial institution;
transforming the ingested data into standardized data using a standardized format, including standardized data types and standardized data structures;
generating enriched data based on applying custom financial data processing on the standardized data;
storing the enriched data in the centralized enterprise data lake, the storing including associating the enriched data with related standardized data in a raw form and a curated form;
automating manual processes for near real-time analytics of the enriched data using orchestrated pipelines; and
causing a user interface to be displayed to a user device, the user interface providing access to self-service data, preparation, and analytics of the enriched data generated by the automated processes stored in the centralized enterprise data lake.

18. The non-transitory machine-readable medium of claim 17, wherein the non-transitory machine-readable medium further includes the instructions that, when executed by the at least one processor, cause the at least one processor to perform the operations comprising:
analyzing the enriched data using a distributed processing framework to determine customer journey data, the customer journey data including one or more interactions with one or more communication channels of the financial institution;
automatically generating a customer journey mapping, the mapping including associating each interaction with each communication channel of the financial institution;
storing the customer journey mapping in the centralized enterprise data lake; and
enabling a user to search the centralized enterprise data lake using a natural language query to identify each interaction of the customer journey mapping based on the enriched data.

19. The non-transitory machine-readable medium of claim 18, wherein the non-transitory machine-readable medium further includes the instructions that, when executed by the at least one processor, cause the at least one processor to perform the operations comprising:
maximizing customer contact and customer engagement with the financial institution based on data-driven insight aggregated from the enriched data;
identifying an optimal communication characteristic to communicate with a customer based on the customer journey mapping, wherein the optimal communication characteristic for the customer includes a time of day and a communication channel, the communication channel including at least one of a physical location, a website application, a mobile application, an online chatbot, or a telephone number; and
identifying the optimal communication characteristic while adhering to a regulatory requirement associated with the customer contact and the customer engagement with the financial institution.

20. The non-transitory machine-readable medium of claim 17, wherein the non-transitory machine-readable medium further includes the instructions that, when executed by the at least one processor, cause the at least one processor to perform the operations comprising, and wherein the automating of manual data collection and reporting processes using the enriched data further comprises:
employing machine learning techniques to analyze query intent and extract data from the centralized enterprise data lake to support data preparation and data analytics;
generating output based on the data preparation and the data analytics, the output including at least one of a report, an intuitive dashboard, or an interactive visualization;
providing access controls to allow different user roles to access different parts of the enriched data; and
providing a simplified user interface tailored to each of the different user roles.
